(19) United States
(12) Patent Application Publication
(10) Pub. No.: US 2026/0288913 A1
(43) Pub. Date: Sep. 24, 2026

(54) LICENSE MANAGEMENT IN CONTAINER PLATFORMS

(71) Applicant: International Business Machines Corporation, Armonk, NY (US)

(72) Inventors: Vishal Anand, Dublin (IE); Nampreet Pal Singh, Pune (IN); VIJAY VIJAYASANKAR, Chandler (AZ); Shrish Srivastava, Munich (DE); Amit Deshpande, New York, NY (US)

(21) Appl. No.: 19/087,536

(22) Filed: Mar. 23, 2025

(51) Int. Cl. G06F 21/10

(52) U.S. Cl. CPC G06F 21/107

(57) ABSTRACT

Management of licenses in container platforms is provided and includes retrieving a set of licenses associated with a container application hosted on a container platform. Consumption data selected from the group consisting of traffic data associated with the container application, transaction data associated with the container application, configuration data associated with the container application, and resource utilization data associated with the container application, is retrieved. A machine learning (ML) model is applied to the set of licenses and the consumption data. Based on the application of the ML model to the set of licenses and the consumption data, the set of licenses is modified, and an allocation of the modified set of licenses to the container application is controlled based on input data associated with the modification of the set of licenses.

### BACKGROUND

The disclosure relates to containerization, and more particularly, to container applications hosted on container platforms.

In recent years, containerization has emerged as a transformative technology in the field of software development and deployment. As organizations increasingly adopt cloud-native architectures, the need for efficient resource utilization, scalability, and rapid deployment has driven the popularity of container platforms. Containers encapsulate applications and dependencies of the applications, allowing the applications to run consistently across various environments. This trend towards the containerization is not only reshaping how software is built and delivered but also how organizations manage the software licenses. This trend demands a need for license management in these container platforms as proper license management helps in ensuring that the organizations can leverage the benefits of containerization while adhering to legal and regulatory obligations.

### SUMMARY

In various embodiments of the disclosure, a computer-implemented method for license management in container platforms is described. The computer-implemented method includes retrieving, by a computer, a set of licenses associated with a container application hosted on a container platform. The computer-implemented method further includes retrieving, by the computer, consumption data that is selected from the group consisting of traffic data associated with the container application, transaction data associated with the container application, configuration data associated with the container application, and resource utilization data associated with the container application. The computer-implemented method further includes applying, by the computer, a machine learning (ML) model to the set of licenses and the consumption data. The computer-implemented method further includes modifying, by the computer, the set of licenses based on the application of the ML model to the set of licenses and the consumption data. The computer-implemented method further includes controlling, by the computer, an allocation of the modified set of licenses to the container application based on input data associated with the modification of the set of licenses associated with the container application.

In various embodiments of the disclosure, a computer system for license management in container platforms is described. The computer system includes a processor set, one or more computer-readable storage media, and program instructions stored on the one or more computer-readable storage media. The program instructions are executable by the processor set and cause the processor set to retrieve a set of licenses associated with a set of container applications hosted on a container platform. The program instructions further cause the processor set to retrieve consumption data that is selected from the group consisting of traffic data associated with each container application of the set of container applications, transaction data associated with each container application of the set of container applications, configuration data associated with each container application of the set of container applications, and resource utilization data associated with each container application of the set of container applications. The program instructions further cause the processor set to apply a machine learning (ML) model to the set of licenses and the consumption data. The program instructions further cause the processor set to modify the set of licenses based on the application of the ML model to the set of licenses and the consumption data. The program instructions further cause the processor set to control an allocation of the modified set of licenses to the set of container applications based on input data associated with the modification of the set of licenses associated with the set of container applications. The program instructions further cause the processor set to control a deployment of each container application of the set of container applications within the container platform based on the allocation of the modified set of licenses to the set of container applications.

In various embodiments of the disclosure, a computer-program product for license management in container platforms is described.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF DRAWINGS

The following description will provide details of preferred embodiments with reference to the following figures, wherein:

FIG. 1 is a diagram that illustrates a computing environment for license management in container platforms, in accordance with an embodiment of the disclosure;

FIG. 2 is a diagram that illustrates an environment for license management in container platforms, in accordance with an embodiment of the disclosure;

FIG. 3 is a diagram that illustrates an exemplary implementation of the computer system of FIG. 2, in accordance with an embodiment of the disclosure;

FIG. 4A is a diagram that illustrates exemplary operations for license management in container platforms, in accordance with an embodiment of the disclosure;

FIG. 4B is a diagram that illustrates exemplary operations for controlling deployments of container applications using the license management, in accordance with an embodiment of the disclosure;

FIG. 5 is a diagram that illustrates an exemplary table for license management in container platforms, in accordance with an embodiment of the disclosure;

FIG. 6 is a diagram that illustrates exemplary operations for training a machine learning (ML) model for license management in container platforms, in accordance with an embodiment of the disclosure;

FIG. 7A is a diagram that illustrates an exemplary first user interface for license management in container platforms, in accordance with an embodiment of the disclosure;

FIG. 7B is a diagram that illustrates an exemplary second user interface for license management in container platforms, in accordance with an embodiment of the disclosure;

FIG. 8 is a diagram that illustrates a flowchart of a first exemplary method for license management in container platforms, in accordance with an embodiment of the disclosure; and

FIG. 9 is a diagram that illustrates a flowchart of a second exemplary method for license management in container platforms, in accordance with an embodiment of the disclosure.

### DETAILED DESCRIPTION

Containerization is a technology that has revolutionized software development and deployment in recent years. The demand for scalability, fast deployment, and effective resource allocation has brought this growth toward containerization as organizations have started embracing cloud-native architecture. Containers encapsulate applications and dependencies of the applications, allowing the applications to run consistently across various environments. This trend towards the containerization is not only reshaping how software is built and delivered but also how organizations manage the software licenses associated with the organizations.

This trend towards the containerization demands a need for license management in these container platforms as proper license management helps in ensuring that the organizations can leverage the benefits of containerization while adhering to legal and regulatory obligations. Furthermore, a well-structured license management process enables the organizations to optimize the software investments, ensuring that they are using the right licenses for the containerized applications.

The applications of license management in container platforms are manifold. Firstly, the license management enables the organizations to maintain compliance with licensing agreements. Furthermore, a proactive approach to license management allows organizations to make informed decisions regarding software procurement and deployment, aligning the licensing strategy with the overall business objectives. This strategic alignment not only enhances operational agility but also fosters innovation, enabling organizations to adopt new technologies and tools that drive growth in an increasingly competitive landscape.

However, the license management in container platforms presents multiple challenges for the organizations, particularly when ensuring compliance with software licensing agreements is concerned. The automated fulfillment of licensing requirements for the software components packed within containers often comes with difficulties. These organizations frequently lack the critical insights into the licensing obligations, which can lead to compliance risks.

The complexity of traditional licensing models further increases the problems for the organizations, especially in environments characterized by elasticity and scalability. Many organizations find themselves navigating vCPU (virtual CPU)-based licensing models, which are commonly employed by software vendors. These vCPU-based licensing models can create significant challenges for organizations operating in dynamic container environments, where resource allocation can fluctuate rapidly. As a result, the organizations may struggle to effectively manage and optimize the licensing agreements, leading to inefficiencies and increased costs. The inability to accurately track and allocate licenses in real-time can also result in unplanned outages of critical applications, disrupting business operations and impacting service delivery.

Moreover, the lack of standardized practices for license management in containerized environments is also a big problem for the organizations. These organizations often face difficulties in establishing consistent processes for monitoring and reporting license usage across various applications. This inconsistency can lead to discrepancies in license consumption, which leads to problems in maintaining compliance and optimizing costs. As organizations continue to adopt containerization as a core part of the IT strategy, there is a need for improved methods for license management.

Traditional methods of license management in container platforms are majorly dependent on these vCPU-based licensing models for license management in container platforms. These vCPU-based licensing models often tie costs directly to the number of virtual CPUs allocated to applications associated with the organizations. In dynamic environments, where resource allocation can change rapidly, these traditional methods lead to inflated licensing costs without a corresponding increase in actual usage. In most cases, these vCPU-based licensing models often cause organizations to waste licenses because they allocate more licenses to the applications than the applications actually need, leaving many licenses unused. Allocating more vCPUs than the applications actually need, leads to increased processing time for controlling the allocating of licenses to the container applications in these container platforms as the computing systems need to control the allocation of unnecessary licenses that may not even need to be allocated.

Further, these vCPU-based licensing models don't provide insights to the organizations about the allocation of the licenses to the applications which leads to compliance risks. Additionally, these vCPU-based licensing models can also lead to unexpected outages of critical applications. In case the resource utilization of the applications associated with the organizations is greater than the licensed vCPU limits, they might face penalties or have the services interrupted, causing the applications to shut down suddenly. Moreover, using too many unnecessary vCPUs can slow down the computing resources, which decreases application performance, increases the chances of outages during busy times, and increases the processing load on the computing system for controlling of allocation of licenses to the container applications.

The disclosed system enables the organizations to interact with the process of license management by providing interactive user interfaces, where the users of the organizations can provide various parameters that they want to be maintained during the management of these licenses. For example, the disclosed system enables the organizations to provide the various parameters such as a cost limit up to which the organizations may be comfortable to extend the allocation of new licenses to the applications. The disclosed system further provides the organizations with insights into the process of license management by generating a protocol table that indicates the users about the allocation of new licenses, the collection back (or deallocation of underutilized licenses), and license consumption trends which indicates the reasons for the new allocations and deallocations of the underutilized licenses.

The disclosed system obtains the license consumption trends of a set of container applications and then applies machine-learning techniques on the license consumption trends to determine the number of licenses that needs to be allocated to keep a respective container application of the set of container applications in the working state. The disclosed system further generates the licenses that need to be allocated in the future in order to keep the set of container applications in a working state and prevent the failure of the set of container applications. The disclosed system further utilizes the determined number of licenses and the obtained license consumption trends to determine the underutilized licenses that can be collected back (or deallocated) from the respective container application in order to optimize the cost of hosting the respective container application and deallocate the unnecessary licenses that are not even being utilized by the respective container application. The disclosed system further controls the allocation of only the licenses that are needed to keep the respective container application in the working state, and deallocates the unnecessary licenses. The disclosed system further ensures that the various parameters (provided by the organizations) are kept in consideration while the disclosed system controls the allocation of the licenses and deallocates the underutilized licenses.

The disclosed system further generates the licenses, in advance, which need to be allocated in order to keep the set of container applications in the working state. Hence the disclosed system reduces the processing load on the computing systems by eliminating the need for generating and the licenses during peak hours, thereby preventing the unplanned outages of set of container applications. Further, the disclosed system deallocates the unnecessary licenses that are not even being utilized by the container applications, thereby controlling the allocation of only the licenses that are needed by the container applications. Controlling only the allocation of the licenses, that are needed by the container applications to keep the container applications in working state eliminates the problems associated with controlling the allocation of the unnecessary licenses that are not even being utilized by the container applications. Hence the disclosed system reduces the processing time for the controlling the allocation of the licenses since now only the allocation of the licenses that are needed to keep the set of container applications in the working state, need to be controlled.

The disclosed system further ensures that the parameters that are provided by the organizations are kept in consideration while controlling the allocation of the new licenses and deallocating the underutilized licenses. Hence, the disclosed system ensures that the process of management of licenses is user-interactive, eliminates the possibilities of compliance risks, and solves the problems associated with the traditional methods. The disclosed system can be implemented as a value-added service for the container platforms that enables user interactive license management.

In various embodiments of the disclosure, a computer-implemented method for license management in container platforms is described. The computer-implemented method includes retrieving, by a computer, a set of licenses associated with a container application hosted on a container platform. The computer-implemented method further includes retrieving, by the computer, consumption data that is selected from the group consisting of traffic data associated with the container application, transaction data associated with the container application, configuration data associated with the container application, and resource utilization data associated with the container application. The computer-implemented method further includes applying, by the computer, a machine learning (ML) model to the set of licenses and the consumption data. The computer-implemented method further includes modifying, by the computer, the set of licenses based on the application of the ML model to the set of licenses and the consumption data. The computer-implemented method further includes controlling, by the computer, an allocation of the modified set of licenses to the container application based on input data associated with the modification of the set of licenses associated with the container application.

In various embodiments of the disclosure, the computer-implemented method further includes generating, by the computer, a protocol table that includes the set of licenses, the modified set of licenses, and the consumption data. The computer-implemented method further includes transmitting, by the computer, the protocol table to a user device. The computer-implemented method further includes receiving, by the computer, the input data associated with the modification of the set of licenses based on the transmission of the protocol table to the user device.

In various embodiments of the disclosure, the computer-implemented method further includes applying, by the computer, the ML model to the set of licenses, the consumption data, and the input data. The input data includes a set of parameters associated with the container application. The computer-implemented method further includes modifying, by the computer, the set of licenses based on the application of the ML model to the set of licenses, the consumption data, and the input data. The computer-implemented method further includes controlling, by the computer, the allocation of the modified set of licenses to the container application based on the set of parameters.

In various embodiments of the disclosure, the set of parameters are selected from the group consisting of a threshold cost associated with the container application, a threshold count of licenses in the modified set of licenses, a threshold count of resources associated with the container application, a threshold count of transactions associated with the container application, and a threshold count of traffic associated with the container application.

In various embodiments of the disclosure, the computer-implemented method further includes controlling, by the computer, a deployment of the container application within the container platform based on the allocation of the modified set of licenses to the container application.

In various embodiments of the disclosure, the computer-implemented method further includes modifying, by the computer, a set of custom resource definitions associated with the container application based on the allocation of the modified set of licenses to the container application. The set of custom resource definitions is indicative of the set of licenses associated with the container application. The set of custom resource definitions is deployed within a control plane of the container platform. The computer-implemented method further includes modifying, by the computer, a set of custom resources associated with the container application based on the allocation of the modified set of licenses to the container application. The set of custom resources is indicative of the set of licenses associated with the container application. The set of custom resources is deployed within a data plane of the container platform. The computer-implemented method further includes controlling, by the computer, the deployment of the container application within the container platform based on the modified set of custom resource definitions and the modified set of custom resources.

In various embodiments of the disclosure, the computer-implemented method further includes controlling, by the computer, a deployment of the modified set of custom resource definitions within the control plane of the container platform. The modified set of custom resource definitions is indicative of the modified set of licenses. The computer-implemented method further includes controlling, by the computer, a deployment of the modified set of custom resources within the data plane of the container platform. The modified set of custom resources is indicative of the modified set of licenses. The computer-implemented method further includes controlling, by the computer, the deployment of the container application within the container platform based on the deployment of the modified set of custom resources and the modified set of custom resource definitions.

In various embodiments of the disclosure, the computer-implemented method further includes retrieving, by the computer, historical consumption data associated with a plurality of container applications and a plurality of licenses associated with the plurality of container applications. The computer-implemented method further includes retrieving, by the computer, a plurality of modified licenses associated with the plurality of container applications. The computer-implemented method further includes generating, by the computer, a training dataset that includes the historical consumption data, the plurality of licenses, and the plurality of modified licenses. The computer-implemented method further includes training, by the computer, the ML model based on the training dataset.

In various embodiments of the disclosure, the computer-implemented method further includes receiving, by the computer, feedback associated with the modified set of licenses. The computer-implemented method further includes training, by the computer, the ML model based on the feedback.

In various embodiments of the disclosure, a computer system for license management in container platforms is described. The computer system includes a processor set, one or more computer-readable storage media, and program instructions stored on the one or more computer-readable storage media. The program instructions are executable by the processor set and cause the processor set to retrieve a set of licenses associated with a set of container applications hosted on a container platform. The program instructions further cause the processor set to retrieve consumption data that is selected from the group consisting of traffic data associated with each container application of the set of container applications, transaction data associated with each container application of the set of container applications, configuration data associated with each container application of the set of container applications, and resource utilization data associated with each container application of the set of container applications. The program instructions further cause the processor set to apply a machine learning (ML) model to the set of licenses and the consumption data. The program instructions further cause the processor set to modify the set of licenses based on the application of the ML model to the set of licenses and the consumption data. The program instructions further cause the processor set to control an allocation of the modified set of licenses to the set of container applications based on input data associated with the modification of the set of licenses associated with the set of container applications. The program instructions further cause the processor set to control a deployment of each container application of the set of container applications within the container platform based on the allocation of the modified set of licenses to the set of container applications.

In various embodiments of the disclosure, the program instructions further cause the processor set to generate a protocol table that includes the set of licenses, the modified set of licenses, and the consumption data. The program instructions further cause the processor set to transmit the protocol table to a user device. The program instructions further cause the processor set to receive the input data associated with the modification of the set of licenses based on the transmission of the protocol table to the user device.

In various embodiments of the disclosure, the program instructions further cause the processor set to apply the ML model to the set of licenses, the consumption data, and the input data. The input data includes a set of parameters associated with each container application of the set of container applications. The program instructions further cause the processor set to modify the set of licenses based on the application of the ML model to the set of licenses, the consumption data, and the input data. The program instructions further cause the processor set to control the allocation of the modified set of licenses to the set of container applications based on the set of parameters.

In various embodiments of the disclosure, the set of parameters are selected from the group consisting of a threshold cost associated with each container application of the set of container applications, a threshold count of licenses in the modified set of licenses, a threshold count of resources associated with each container application of the set of container applications, a threshold count of transactions associated with each container application of the set of container applications, and a threshold count of traffic associated with each container application of the set of container applications.

In various embodiments of the disclosure, the program instructions further cause the processor set to modify a set of custom resource definitions associated with the set of container applications based on the allocation of the modified set of licenses to the set of container applications. The set of custom resource definitions is indicative of the set of licenses associated with the container application. The set of custom resource definitions is deployed within a control plane of the container platform. The program instructions further cause the processor set to modify a set of custom resources associated with the set of container applications based on the allocation of the modified set of licenses to the set of container applications. The set of custom resources is indicative of the set of licenses associated with the container application. The set of custom resources is deployed within a data plane of the container platform. The program instructions further cause the processor set to control the deployment of each container application of the set of container applications within the container platform based on the modified set of custom resource definitions and the modified set of custom resources.

In various embodiments of the disclosure, the program instructions further cause the processor set to control a deployment of the modified set of custom resource definitions within the control plane of the container platform. The modified set of custom resource definitions is indicative of the modified set of licenses. The program instructions further cause the processor set to control a deployment of the modified set of custom resources within the data plane of the container platform. The modified set of custom resources is indicative of the modified set of licenses. The program instructions further cause the processor set to control the deployment of each container application of the set of container applications within the container platform based on the deployment of the modified set of custom resources and the modified set of custom resource definitions.

In various embodiments of the disclosure, the program instructions further cause the processor set to retrieve historical consumption data associated with a plurality of container applications and a plurality of licenses associated with the set of container applications. The program instructions further cause the processor set to retrieve a plurality of modified licenses associated with the plurality of container applications. The program instructions further cause the processor set to generate a training dataset that includes the historical consumption data, the plurality of licenses, and the plurality of modified licenses. The program instructions further cause the processor set to train the ML model based on the training dataset.

In various embodiments of the disclosure, the program instructions further cause the processor set to receive feedback associated with the modified set of licenses. The program instructions further cause the processor set to train the ML model based on the feedback.

In various embodiments of the disclosure, a computer-program product for controlling an allocation of a set of licenses to a container application is described. The computer program product includes one or more computer-readable storage media and program instructions stored in the one or more computer-readable storage media to perform operations that include retrieving the set of licenses associated with the container application hosted on a container platform. The operations further include retrieving consumption data that is selected from the group consisting of traffic data associated with the container application, transaction data associated with the container application, configuration data associated with the container application, and resource utilization data associated with the container application. The operations further include applying a machine learning (ML) model to the set of licenses and the consumption data. The operations further include modifying the set of licenses based on the application of the ML model to the set of licenses and the consumption data. The operations further include controlling the allocation of the modified set of licenses to the container application based on input data associated with the modification of the set of licenses associated with the container application.

In various embodiments of the disclosure, the operations further include generating a protocol table that includes the set of licenses, the modified set of licenses, and the consumption data. The operations further include transmitting the protocol table to a user device. The operations further include receiving the input data associated with the modification of the set of licenses based on the transmission of the protocol table to the user device.

In various embodiments of the disclosure, the operations further include applying the ML model to the set of licenses, the consumption data, and the input data. The input data includes a set of parameters associated with the container application. The set of parameters are selected from the group consisting of a threshold cost associated with the container application, a threshold count of licenses in the modified set of licenses, a threshold count of resources associated with the container application, a threshold count of transactions associated with the container application, and a threshold count of traffic associated with the container application. The operations further include modifying the set of licenses based on the application of the ML model to the set of licenses, the consumption data, and the input data. The operations further include controlling the allocation of the modified set of licenses to the container application based on the set of parameters.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

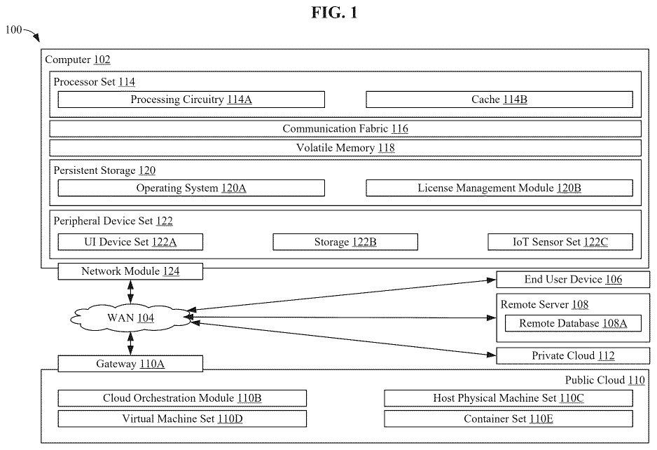

FIG. 1 is a diagram that illustrates a computing environment for license management in container platforms, in accordance with an embodiment of the disclosure. With reference to FIG. 1, there is shown a computing environment 100 that contains an example of an environment for the execution of at least some of the computer code involved in performing the disclosed methods, such as a license management module 120B. In addition to the license management module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the license management module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the license management module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the license management module 120B typically includes at least some of the computer code involved in performing the disclosed methods.

The peripheral device set 122 includes the set of peripheral devices of computer 102. Data communication connections between the peripheral devices and the various components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, the storage 122B may take the form of a quantum computing storage device for storing data in the form of qubits. In embodiments of the disclosure where the computer 102 is needed to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with various computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through WAN 104 to EUD 106. In this way, the EUD 106 can display, or otherwise present recommendations to an end user. In some embodiments of the disclosure, the EUD 106 may be a client device, such as a mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is shown as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

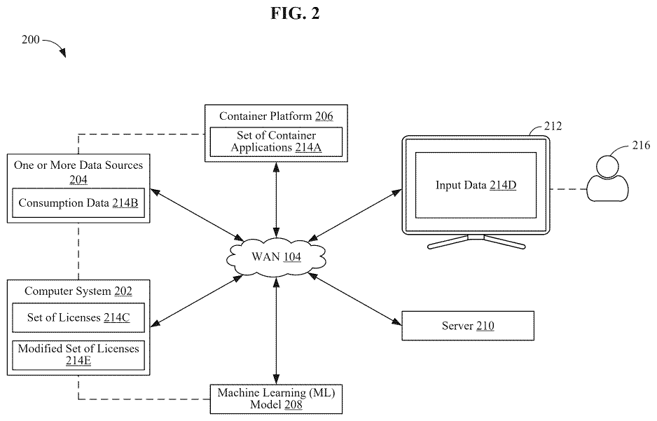

FIG. 2 is a diagram that illustrates an environment for license management in container platforms, in accordance with an embodiment of the disclosure. FIG. 2 is explained in conjunction with elements from FIG. 1. With reference to FIG. 2, there is shown a diagram of a network environment 200. The network environment 200 includes a computer system 202 (may be referred to as a system 202 hereinafter), one or more data sources 204, a container platform 206, a machine learning (ML) model 208, a server 210, and a user device 212. The container platform 206 is configured to host a set of container applications 214A (may be referred to as a set of applications 214A, hereinafter). The one or more data sources 204 stores consumption data 214B associated with the set of container applications 214A. The system 202 is configured to retrieve a set of licenses 214C associated with the set of container applications 214A. The system 202 is further configured to receive input data 214D from the user device 212 and generate a modified set of licenses 214E for the set of container applications 214A. The user device 212 is further associated with a user 216. The network environment 200 further includes the WAN 104 of FIG. 1. In an embodiment of the disclosure, the user device 212 is an exemplary embodiment of the EUD 106. Similarly, the computer system 202 is an exemplary embodiment of the computer 102 in FIG. 1.

The system 202 includes suitable logic, circuitry, code, and/or interfaces that are configured to manage the set of licenses 214C within the container platform 206. Specifically, the system 202 is configured to retrieve the set of licenses 214C associated with the set of container applications 214A. The system 202 is further configured to retrieve the consumption data 214B associated with the set of container applications 214A (may be referred to as the set of applications 214A, hereinafter). The consumption data 214B is selected from the group that includes traffic data associated with each application of the set of applications 214A, transaction data associated with each application of the set of applications 214A, configuration data associated with each application of the set of applications 214A, and resource utilization data associated with each application of the set of applications 214A. The system 202 is further configured to apply the ML model 208 to the set of licenses 214C and the consumption data 214B. The system 202 is further configured to modify the set of licenses 214C associated with the set of applications 214A based on the application of the ML model 208 to the set of licenses 214C and the consumption data 214B. The system 202 is further configured to control an allocation of the modified set of licenses 214E to the set of container applications 214A based on the input data 214D associated with the modification of the set of licenses 214C.

Examples of the system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the system 202 may be embodied as a cloud-based service, a cloud-based application, a cloud-based platform, a remote server-based service, a remote server-based application, a remote server-based platform, or a virtual computing system.

Each data source of the one or more data sources 204 corresponds to an organized collection of data that may be stored and accessed electronically from a computer system (such as the system 202). Each of the one or more data sources 204 may be designed to manage, store, retrieve, and update data efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment, each data source of the one or more data sources 204 are connected to the application programming interfaces (APIs) of the container platform 206. In an embodiment, each data source of the one or more data sources 204 stores the consumption data 214B associated with the set of applications 214A The consumption data 214B includes the traffic data associated with the set of applications 214A, the transaction data associated with the set of applications 214A, the configuration data associated with the set of applications 214A, and the resource utilization data associated with the set of applications 214A.

In an embodiment, the traffic data indicates a volume of data transmitted to and from each application of the set of applications 214A. The traffic data further indicates the number of user interactions and network load on each application of the set of applications 214A. For example, the traffic data for a web application may include the number of HTTP requests received by the web application per minute.

In an embodiment, the resource utilization data indicates consumption of resources (such as vCPUs, memory, disk I/O, network bandwidth, or the like) by each application of the set of applications 214A. The resource utilization data further indicates the allocation of different resources to each application of the set of applications 214A. For example, the resource utilization data for an application may include the average vCPU usage percentage of the application over a specific time period.

In an embodiment, the transaction data indicates the details of individual transactions processed by each application of the set of applications 214A, including inputs, outputs, and timestamps. The transaction data is vital for auditing, performance analysis, and understanding user interactions. For example, the transaction data may include a log entry detailing a completed purchase in an e-commerce application, including the transaction ID, user ID, items purchased, and the timestamp of the transaction.

In an embodiment, the configuration data includes the specific configuration settings and configuration parameters that define how each application of the set of applications 214A and the environments of the respective application are set up. The configuration data is critical for maintaining consistency across various deployments of the set of applications 214A. For example, the configuration data includes specific environment variables set for an application, such as resource limits.

Examples of each data source of the one or more data sources 204 may include but are not limited to, a relational database, a Non-Structured Query Language (SQL) database, a hierarchical database, a network database, a transactional database, a data warehouse, and a distributed database.

The container platform 206 includes suitable logic, circuitry, interfaces, and/or code that may be configured to host the set of applications 214A. The container platform 206 is a software framework that enables the deployment, management, and scaling of containerized applications. The container platform 206 provides a consistent runtime environment by encapsulating each application of the set of applications 214A and the dependencies of the respective application within containers, ensuring seamless operation across various computing environments. The container platform 206 offers tools and services for orchestrating containers, optimizing resource utilization, and automating tasks such as scaling and fault tolerance.

In an embodiment, each application of the set of applications 214A is hosted on the container platform 206. Specifically, hosting an application on the container platform 206 involves several key processes to ensure that the application runs efficiently and reliably. Firstly, a docker file is created to define the environment of the application, dependencies, and relevant instructions to build the application image. An application image is then pushed to a container registry. Further, deployment configurations, typically using Yet Another Markup Language (YAML) files, are crafted to define the desired state of the application, specifying details such as the number of replicas, resource limits, and networking requirements. Such configurations are applied using container orchestration tools, which manage the deployment, scaling, and operation of the application containers across a cluster of nodes. Additional configurations might include setting up persistent storage, configuring environment variables and secrets for sensitive data, and setting up monitoring and logging to track the application's performance and health.

Each application of the applications 214A includes suitable logic and/or code that is designed to perform specific tasks or functions, which can range from web services to data processing tools. Specifically, each application of the set of applications 214A is built using various programming languages and frameworks, and each application of the set of applications 214A relies on specific dependencies and configurations to operate effectively. By way of example, and not by limitation, each application of the set of applications 214A could be a website that serves dynamic content, a database management system, a microservice that handles user authentication, and the like.

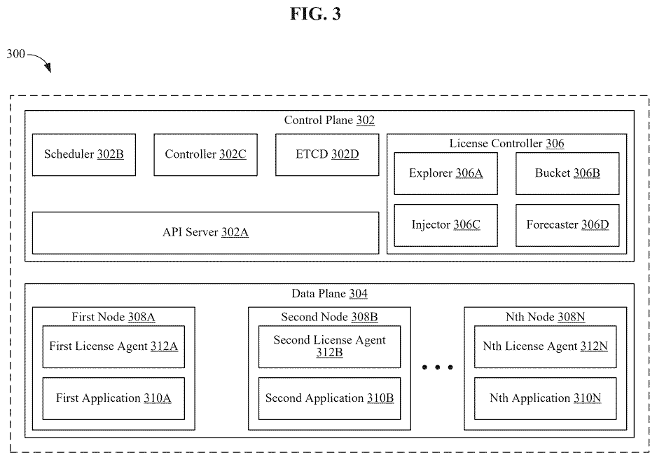

In an embodiment, the container platform 206 is implemented as a plurality of distributed cloud-based resources by use of several technologies that are well known to those ordinarily skilled in the art. A person with ordinary skill in the art will understand that the scope of the disclosure may not be limited to the implementation of the container platform 206 and the system 202 as two separate entities. In certain embodiments, the functionalities of the container platform 206 can be incorporated in its entirety or at least partially in the system 202, without a departure from the scope of the disclosure. Details about the implementation of the system 202 as a part of the container platform 206 are provided, for example, in FIG. 3.

The ML model 208 corresponds to a neural network-based regression model. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of the nodes in the input layer may be coupled to at least one node of the hidden layer(s). Similarly, the inputs of each hidden layer are coupled to outputs of at least one node in various layers of the neural network. Outputs of each hidden layer may be coupled to inputs of at least one node in various layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on the training dataset. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in various layer(s) (e.g., previous layer(s)) of the neural network. Each node or some of the nodes of the neural network correspond to the same or a different mathematical function.

In the training of the ML model 208, one or more parameters of each node of the ML model 208 may be updated based on whether an output of the final layer for a given input (from the training dataset) matches a correct result based on a loss function for the ML model 208. The above process may be repeated for the same or a different input until a minima of loss function may be achieved, and a training error may be minimized.

The neural network includes electronic data, such as, for example, a software program, code of the software program, libraries, applications, scripts, or various logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the ML model 208 is a separate entity in the system 202 is configured to, without deviation from the scope of the disclosure.

In an embodiment, the ML model 208 is configured to modify the set of licenses 214C associated with the set of applications 214A based on the consumption data 214B. In an embodiment, the ML model 208 analyzes that the traffic on the set of applications 214A is increasing and predicts the modified set of licenses 214E (new licenses) that need to be allocated to the set of container applications 214A. In an alternate embodiment, the ML model 208 analyzes that the traffic on the set of licenses is decreasing, then the ML model 208 predicts that the underutilized licenses can be collected back (or deallocated) from the set of applications 214A to maintain the cost of hosting the set of applications 214A. In an embodiment, the system 202 is configured to store the ML model 208. In an alternate embodiment, the ML model 208 is embodied as a separate entity that is implemented as a set of distributed cloud-based resources by use of several technologies that are well known to those ordinarily skilled in the art. Examples of the ML model 208 include one of but are not limited to, an artificial neural network (ANN), a deep neural network (DNN), a convolutional neural network (CNN), a fully connected neural network, and/or a combination of such networks.

The server 210 includes suitable logic, circuitry, interfaces, and/or code that stores the set of instructions. The server 210 can be implemented as a cloud server and may execute operations through web applications, cloud applications, HTTP requests, repository operations, file transfer, and the like. Various implementations of the server 210 include but are not limited to, a database server, a file server, a web server, a media server, an application server, a mainframe server, or a cloud computing server.

In an embodiment, the server 210 is implemented as a plurality of distributed cloud-based resources by use of several technologies that are well known to those ordinarily skilled in the art. A person with ordinary skill in the art will understand that the scope of the disclosure may not be limited to the implementation of the server 210 and the system 202 as two separate entities. In certain embodiments, the functionalities of the server 210 can be incorporated in its entirety or at least partially in the system 202, without a departure from the scope of the disclosure.

The user device 212 includes suitable logic, circuitry, and/or interfaces that are configured to execute one or more tasks within the network environment 200. The user device 212 performs the one or more tasks such as receiving data, processing the data, and transmitting the data. In an embodiment, the system 202 is configured to receive the input data 214D from the user device 212. The input data 214D includes a set of parameters associated with the modification of the set of licenses 214C associated with the set of applications 214A.

In an embodiment, the set of parameters are selected from the group that includes a first threshold cost associated with hosting each application of the set of applications. The first threshold cost may indicate the threshold limit of the cost that the user 216 may be comfortable to provide for hosting the respective application of the set of applications 214A. In an embodiment, the set of parameters are selected from the group that further includes a threshold count of licenses in the modified set of licenses 214E. The threshold count of licenses may indicate the limit of the number of licenses that the user may want to be allocated to the respective application of the set of applications 214A, in order to maintain the cost of hosting the respective application under the first threshold cost. It may be noted that the increase in the number of licenses for each application of the set of applications 214A corresponds to an increase in the cost of hosting the respective application, hence, the system 202 may be configured to determine the number of licenses that need to be allocated to each application of the set of applications 214A to maintain the cost of hosting the respective application under the first threshold cost.

In an embodiment, the set of parameters are selected from the group that may further include a first threshold limit of traffic on each application of the set of applications 214A. The first threshold limit of traffic may indicate the limit of traffic that the user may want on the respective application of the set of applications 214A, in order to maintain the cost of hosting the respective application under the first threshold cost. In an embodiment, the set of parameters selected from the group that may further include a first threshold limit of resources that need to be allocated to each application of the set of applications 214A. The first threshold limit of resources may further indicate the limit of resources that the user 216 may want to be allocated to the respective application, in order to maintain the cost of hosting the respective application under the first threshold cost.

In an embodiment, the set of parameters selected from the group that may further include a first threshold limit of transactions that can be performed by each application of the set of applications 214A. The first threshold limit of transactions may indicate the limit on the number of transactions that the user may want to be performed by the respective application, in order to maintain the cost of hosting the respective application under the first threshold cost. It may be noted that the increase in the number of resources, traffic, and transactions, corresponds to an increase in the cost of hosting the respective application, hence the system 202 may be configured to determine the limit of the number of resources (that can be allocated), the limit of traffic, and the limit of the number of transactions in order to maintain the cost of hosting the respective application under the first threshold cost.

In an alternate embodiment, the system 202 is configured to render a message on the user device 212. The message is associated with the allocation of the modified set of licenses 214E to the set of container applications 214A. By way of example, and not by limitation, the message may be “Licenses have been allocated to the applications successfully”. Examples of the user device 212 include one but are not limited to, a smartphone, a cellular phone, a mobile phone, a consumer electronic (CE) device, an Internet of Things (IOT) device, a computing device, a mainframe machine, a server, a computer workstation, or the like.

In operation, the system 202 is configured to retrieve the set of licenses 214C associated with the set of applications 214A. Each license of the set of licenses indicates the licenses that are currently allocated to the set of applications 214A. In an embodiment, each license of the set of licenses 214C corresponds to a legal agreement between the software provider (licensor) and the user or an organization (licensee). Each license of the set of licenses grants the licensee the right to use the software under specified conditions. This legal agreement outlines the terms of use, including the scope, duration, limitations, and the obligations associated with the software. For example, a specific user may have purchased a software license for a specific version of a database management system (DBMS) that allows the specific user to install and use the software for an application hosted on the container platform. In an embodiment, the system 202 is configured to retrieve the set of licenses associated with the set of applications 214A from the one or more data sources 204. As discussed above, the one or more data sources 204 are connected to the container platform via the APIs. Hence, the system 202 is configured to retrieve the set of licenses via the API calls.

In an embodiment, each license of the set of licenses 214C may further indicate a second threshold limit of resources that can be allocated to each application of the set of applications 214A under the terms and conditions of the corresponding license. For example, a specific license may indicate the number of vCPU resources (8 vCPUs) that can be allocated to a specific application. In an embodiment, each license of the set of licenses 214C may further indicate a second threshold limit of traffic on each application of the set of applications 214A under the terms and conditions of the license. For example, a specific license may restrict up to 500 GB of data transfer per month for an application. In an embodiment, each license of the set of licenses 214C may further indicate a second threshold limit of transactions that can be performed by each application of the set of applications 214A. For example, a specific license restricts an application to perform 100,000 transactions a month. Each license of the set of licenses 214C may further indicate a cost that the user needs to provide to host the respective application of the set of applications 214A. For example, a specific license may indicate that the user needs to provide $200/month for hosting an application.

By way of an example, and not by limitation, the system 202 identifies that 3 licenses have been allocated to each of a first application and a second application of the set of applications. Each license of the 3 licenses indicates that the first application and the second application can be allocated 8 vCPUs based on the terms and conditions of the license. Hence, according to the 3 licenses, the first application and the second application can be allocated 24 vCPUs (8*3) each. The 3 licenses indicate that the user needs to provide a total of $600/month ($200*3) each for hosting the first application and the second application.

Thereafter, the system 202 is configured to retrieve the consumption data 214B associated with each application of the set of applications 214A from the one or more data sources 204. As discussed above, the consumption data 214B is selected from the group that includes the traffic data associated with each application of the set of applications 214A, the transaction data associated with each application of the set of applications 214A, the configuration data associated with each application of the set of applications 214A, and the resource utilization data associated with each application of the set of applications 214A.

By way of example, and not by limitation, the system 202 obtains the consumption data associated with the first application and the second application. The resource utilization data indicates that the first application is currently utilizing 22 vCPUs of the 24vCPUs that have been allocated, and the traffic data indicates that the traffic on the first application is increasing progressively. The resource utilization data further indicates that the second application is currently utilizing 14 vCPUs of the 24vCPUs that have been allocated, and the traffic data indicates that the traffic on the second application is decreasing progressively.

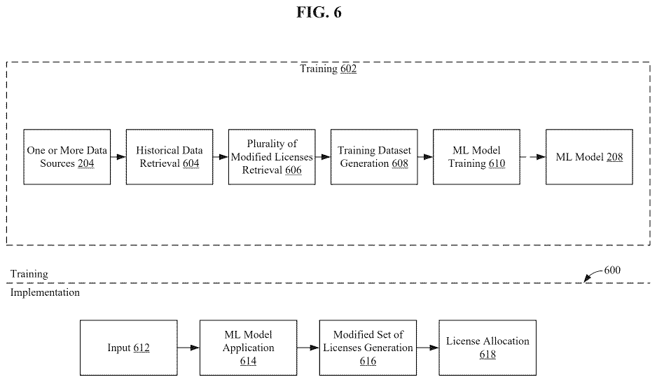

Further, the system 202 is configured to apply the ML model 208 to the set of licenses 214C and the consumption data 214B. The ML model 208 is configured to analyze the consumption data 214B and the set of licenses that are currently allocated to each application of the set of applications. Based on the analysis, the ML model 208 is further configured to predict the number of licenses (modified set of licenses 214E) that need to be allocated to the respective application to maintain the respective application in a working state while maintaining the cost of hosting the respective application. The ML model 208 is trained to predict the modified set of licenses 214E based on the set of licenses 214C and the consumption data 214B. Details about the training of the ML model 208 are provided, for example, in FIG. 6 and its corresponding description.

Thereafter, the system 202 is configured to modify the set of licenses 214C that are currently allocated to the set of applications 214A based on the application of the ML model to the set of licenses 214C and the consumption data 214B. In an embodiment, each license of the modified set of licenses 214C indicates a scaling (upscaling or downscaling) of the respective application of the set of applications 214A. In an embodiment, the count of licenses in the modified set of licenses indicates the number of licenses that need to be allocated to each application of the set of applications 214A, to maintain the respective application in a working state while maintaining the cost of hosting the respective application. In an embodiment, the modified set of licenses 214E indicates the licenses that need to be allocated to the respective container application to keep the respective container application of the set of container applications 214A in the working state.

By way of example, and not by limitation, the system 202 determines that 1 additional license needs to be allocated to the first application, since the first application is currently utilizing 22 vCPUs of the 24vCPUs that are allocated, under the terms and conditions of the 3 licenses allocated, and the traffic on the first application is increasing progressively. Hence, the system 202 modifies the set of licenses associated with the first application from 3 licenses to 4 licenses. The system 202 further determines that 1 license can be collected back from the second application since the second application is currently utilizing only 14 vCPUs of the 24 vCPUs allocated to it, and the traffic on the second application is decreasing progressively.

To this end, the system 202 is further configured to control the allocation of the modified set of licenses 214E to the set of applications 214A based on the input data 214D associated with the modification of the set of licenses 214C. In an embodiment, the system 202 receives the input data 214D from the user device 212 and then controls the allocation of the modified set of licenses 214E. In an embodiment, the system 202 is further configured to allocate new licenses to the set of applications 214A and collect back (or deallocate) the underutilized licenses currently allocated to the set of applications 214A based on the input data 214D. The input data 214D may indicate an approval of the modified set of licenses or the input data 214D may include the set of parameters associated with the modified set of licenses 214E.

In an embodiment, for the allocation of new licenses, the system 202 is configured to obtain the license agreement, get the license agreement digitally signed from the user 216 via the user device 212, and then submit the license agreement to the licensor for approval. Similarly, for the deallocation of the licenses, the system 202 is configured to obtain a license cancellation document from the one or more data sources 204, get the license cancellation document digitally signed by the user 216 via the user device 212, and then submit the license cancellation document to the licensor for cancellation. Similar to the license agreement, the license cancellation document is a legal agreement between the licensee and the licensor, for the cancellation of licenses.

As discussed above, the set of parameters may include the first threshold cost that the user is comfortable to provide for hosting each application of the set of applications 214A, the first threshold count of licenses in the modified set of licenses 214E, the first threshold count of resources that the user may want to be allocated to the set of applications 214A, the first threshold count of transactions that the user may want to be performed by the set of applications 214A, and the first threshold count of traffic associated with the set of container applications 214A.

By way of example, and not by limitation, the system 202 receives the first threshold cost that the user is comfortable to provide as $1000/month for each of the first application and the second application. The system 202 further receives an approval to collect back one license from the second application. The system 202 determines that the total cost of hosting the first application upon the allocation of 1 additional license to the first application ($800/month) is less than the first threshold cost ($1000/month). Hence, the system 202 allocates 1 additional license to the first application and collects back (deallocates) 1 license from the 3 licenses allocated to the second application. The system 202 similarly obtains the license agreement (first application) and the license cancellation document (second application), get the license agreement and the license cancellation document digitally signed by the user 216 via the user device 212, and submit the license agreement and the license cancellation document to the licensor.

Since the system 202 is configured to control the allocation of only the modified set of licenses 214E, that is needed to keep the set of container applications 214A in the working state, hence the system 202 reduces the processing time for controlling the allocation of the licenses. Controlling only the allocation of the modified set of licenses 214E that are needed by the container applications to keep the container applications in working state eliminates the problems associated with controlling the allocation of the unnecessary licenses that are not even being utilized by the set of container applications 214A. Hence the system 202 reduces the processing time for the controlling the allocation of the licenses since now only the allocation of the modified set of licenses 214E that are needed to keep the set of container applications 214A in the working state, needs to be controlled.

FIG. 3 is a diagram that illustrates an exemplary implementation of the computer system 202 of FIG. 2 for license management in the container platform, in accordance with an embodiment of the disclosure. FIG. 3 is explained in conjunction with elements from FIG. 1 and FIG. 2. With reference to FIG. 3, there is shown a container platform 300. The container platform 300 includes a control plane 302 and a data plane 304. The control plane 302 includes an API server 302A of the container platform 300, a scheduler 302B of the container platform 300, a controller 302C of the container platform 300, and an etcd server 302D of the container platform 300. The control plane 302 further includes a license controller 306. The license controller 306 includes an explorer 306A, a bucket 306B, an injector 306C, and a forecaster 306D. The data plane 304 includes a set of nodes of the container platform 300. Each node of the set of nodes hosts the set of applications 214A. The set of nodes includes a first node 308A that hosts a first application 310A of the set of applications 214A, a second node 308B that hosts a second application 310B of the set of applications 214A, up to an Nth node 308N that hosts an Nth application 310N of the set of applications 214A. The set of nodes further includes a set of license agents for the set of applications 214A. The set of license agents includes a first license agent 312A, a second license agent 312B, up to an Nth license agent 312N. The container platform 300 is an exemplary embodiment of the container platform 206 of FIG. 2. Similarly, the first application 310A, the second application 310B, and the Nth application 310N are exemplary embodiments of the set of applications 214A.

The control plane 302 of the container platform 300 includes suitable logic, code, circuitry, and/or interfaces that are configured for the orchestration, management, and overall lifecycle of the set of applications 214A. The control plane 302 includes various elements, including the API server 302A, the scheduler 302B, the controller 302C, and the etcd server 302D which collectively ensure that the desired state of each application of the set of applications 214A is achieved and maintained. The control plane 302 is configured to process user requests and configurations, monitor the health of the set of nodes, and communicate with worker nodes to manage the deployment and operation of containers.

The API server 302A serves as the central interface for users and various components to interact with the control plane, allowing for the submission of commands and retrieval of information regarding the state of the cluster (the set of nodes). The scheduler 302B includes suitable logic, code, circuitry, and/or interfaces that are configured to determine the placement of the containers on the set of nodes based on resource requirements and constraints. In an embodiment, the scheduler is used to ensure efficient utilization of computing resources. The controller 302C oversees the various controllers of the container platform 300 that monitors the state of the set of applications 214A and makes the adjustments that are needed to maintain the desired configuration. The etcd server 302D acts as a distributed key-value store that maintains the persistent state of the control plane 302 in the container platform 300. The etcd server 302D stores critical configuration data and state information, allowing the components of the controller 302C to monitor changes and ensure the set of applications 214A operates in the desired state.

The data plane 304 of the container platform 300 includes suitable logic, code, circuitry, and/or interfaces for data processing and communication between the containers. The data plane 304 executes one or more operations such as routing of network traffic, storage management, and data transfer, ensuring efficient and reliable interactions with the set of applications 214A while maintaining performance and scalability. The data plane 304 mainly focuses on the execution of workloads and the management of data flow. The data plane 304 is designed to enable data transfer and processing, allowing containers to communicate with each other and access shared resources seamlessly.

The license controller 306 corresponds to an exemplary implementation of the system 202 of FIG. 1. In an embodiment, the system 202 may be deployed as a part of the container platform 300 using custom resource definitions (CRDs) (for the license controller 306) and custom resources (for the set of license agents). The CRDs are used to extend the functionalities of the container platform 300 by defining custom resources. These CRDs serve as a blueprint for generating custom resources, by specifying the schema, validation rules, and behavior of the custom resources. By utilizing these CRDs, the system 202 can be implemented as a part of the container platform 300, which can be used to extend the functionality of the container platform 300, in order to support license management as discussed in FIG. 2. Hence, the system 202 can be implemented as a value-added service for the container platform 300 that supports license management.

As discussed above, the CRDs (the license controller 306) are generated and deployed in the control plane 302 of the container platform 300 that defines the extended functionality (license management in this case), whereas the real-time instance custom resources (the set of license agents) are deployed in the data plane 304, that actually extends the functionality. With reference to FIG. 3, the license controller 306 includes the explorer 306A, the bucket 306B, the injector 306C, and the forecaster 306D. Each of the explorer 306A, the bucket 306B, the injector 306C, and the forecaster 306D are implemented along with the CRDs and communicate with the API server 302A, for communication with the set of license agents.

The explorer 306A includes suitable logic, circuitry, code, and/or interfaces that are configured to poll the set of applications 214A running in the data plane 304. Based on the polls, the explorer 306A is configured to analyze the utilization of the set of licenses 214C and the consumption data 214B (including during scaling (up or down)) and prepare a data table. In an embodiment, the explorer 306A is configured to request the bucket 306B to allocate more specific licenses to specific application(s). In an alternate embodiment, the explorer is further configured to request the bucket 306B to collect back specific licenses from specific applications (underutilization scenario).

The bucket 306B includes suitable logic, circuitry, code, and/or interfaces that are configured to store the set of licenses associated with the set of applications 214A running in the data plane 304. In an embodiment, the bucket 306B is configured to communicate with the explorer 306A for the allocation and collection of the licenses. In an embodiment, the bucket 306B is further configured to allocate new licenses or collect back licenses (underutilization scenario). In an embodiment, the bucket 306B is further configured to communicate with the injector 306C for future licenses (forecast).

The injector 306C includes suitable logic, circuitry, code, and/or interfaces that are configured to receive the input data 214D from the user device 212. In an embodiment, the injector 306C ensures that bucket 306B every time has an adequate number of licenses according to set of parameters defined. In an embodiment, the injector 306C is further used to obtain the approval of the user 216 for the allocation and the deallocation of the licenses as discussed in FIG. 2.

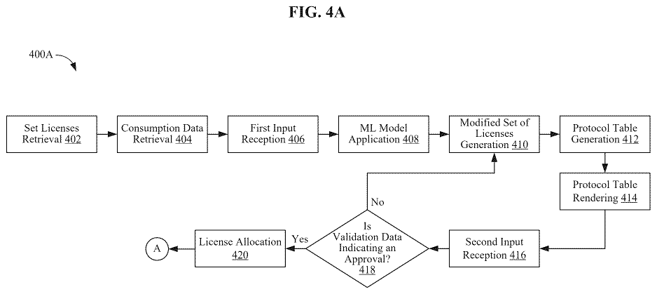

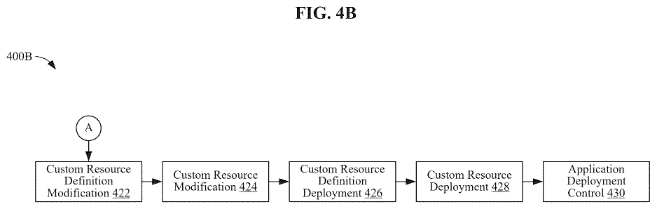

The forecaster 306D includes suitable logic, circuitry, code, and/or interfaces that are configured to predict the adequate number of licenses that need to be allocated to each application of the set of applications 214A to maintain the respective application in the working state while maintaining the cost of hosting the respective application. The forecaster 306D predicts the adequate number of licenses based on the set of licenses 214C which are currently allocated and the consumption data 214B. The forecaster is further configured to generate a protocol table. Details about the protocol table are provided, for example, in FIG. 4A.

Each node of the set of nodes (each of the first node 308A, the second node 308B, up to the Nth node 308N) includes suitable logic, code, circuitry, and/or interfaces that are configured to run the set of applications 214A (the first application 310A, the second application 310B, up to the Nth application 310N). Each node of the set of nodes includes the physical or virtual machines that provide the computational resources which are critical to run the set of applications 214A. Each node of the set of nodes is equipped with the critical hardware and software components to host one or more containers, enabling the execution of the set of applications 214A.

Each license agent of the set of license agents (the first license agent 312A, the second license agent 312B, up to the Nth license agent 312N) corresponds to a respective run time instance of the license controller 306. Each license agent of the set of license agents is configured to perform license management for the respective application of the set of applications 214A. In an embodiment, each license agent of the set of license agents similarly includes the explorer 306A, the bucket 306B, the injector 306C, and the forecaster 306D for managing the licenses for the respective application of the set of applications 214A. Each license agent of the set of license agents communicates with the license controller to perform license management.

FIG. 4A is a diagram that illustrates exemplary operations for license management in container platforms, in accordance with an embodiment of the disclosure. FIG. 4A is explained in conjunction with elements from FIG. 1, FIG. 2, and FIG. 3. With reference to FIG. 4A, there is shown the block diagram 400A that illustrates exemplary operations from 402 to 420, as described herein. The exemplary operations illustrated in the block diagram 400A start at 402 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400A can be divided into additional blocks, combined into fewer blocks, or eliminated, depending on the implementation.

At 402, a set of licenses retrieval operation is performed. In the set of licenses retrieval operation, the system 202 is configured to retrieve the set of licenses 214C that are currently allocated to the set of applications 214A from the one or more data sources 204. As discussed above, the one or more data sources 204 are connected with the APIs of the container platform 206. In an embodiment, the system 202 is configured to obtain the set of licenses 214C via the API calls. By way of an example, and not by limitation, the system 202 identifies that 3 licenses have been allocated to each of a first application and a second application of the set of applications. Each license of the 3 licenses indicates that the first application and the second application are allowed the data transfer of 200 GB of data transfer per month based on the terms and conditions of the license. Hence, according to the 3 licenses, the first application and the second application can be allowed the data transfer of 600 GB (200*3) each. The 3 licenses further indicate that the user needs to provide a total of $600/month ($200*3) each for hosting the first application and the second application.

At 404, a consumption data retrieval operation is performed. In the consumption data retrieval operation, the system 202 is configured to retrieve the consumption data 214B associated with each application of the set of applications 214A from the one or more data sources 204. As discussed above, the consumption data 214B includes the traffic data associated with each application of the set of applications 214A, the transaction data associated with each application of the set of applications 214A, the configuration data associated with each application of the set of applications 214A, and the resource utilization data associated with each application of the set of applications 214A.

By way of example, and not by limitation, the system 202 obtains the consumption data associated with the first application and the second application. The traffic data indicates that the first application is currently performing 590 GB of data transfer per month, and the traffic data indicates that the traffic on the first application is increasing progressively. The traffic data further indicates that the second application is currently performing 400 GB of data transfer per month, and the traffic data indicates that the traffic on the second application is decreasing progressively.

At 406, a first input reception operation is performed. In the first input reception operation, the system 202 is configured to receive the input data 214D associated with the modification of the set of licenses 214C that is currently allocated to the set of applications 214A. In an embodiment, the input data 214D includes the set of parameters associated with the modification of the set of licenses 214C. In an embodiment, the set of parameters may include the first threshold cost that the user is comfortable to provide for hosting each application of the set of applications 214A, the first threshold count of licenses in the modified set of licenses 214E, the first threshold count of resources that the user may want to be allocated to the set of applications 214A, the first threshold count of transactions that the user may want to be performed by the set of applications 214A, or the first threshold count of traffic associated with the set of container applications 214A. By way of example, and not by limitation, the system 202 receives the first threshold cost that the user 216 is comfortable to provide as $1000/per month.

At 408, an ML model application operation is performed. In the ML model application operation, the system 202 is configured to apply the ML model 208 to the set of licenses 214C, the consumption data 214B, and the input data 214D. The ML model 208 is configured to analyze the consumption data 214B and the set of licenses that are currently allocated to each application of the set of applications. Based on the analysis, the ML model 208 is further configured to predict the number of licenses (modified set of licenses 214E) that need to be allocated to the respective application to maintain the respective application in the working state while maintaining the set of parameters (the first threshold cost) provided in the input data 214D. The ML model 208 is trained to predict the modified set of licenses 214E based on the set of licenses 214C and the consumption data 214B. Details about the training of the ML model 208 are provided, for example, in FIG. 6 and its corresponding description.

At 410, a modified set of licenses generation operation is performed. In the modified set of licenses generation operation, the system 202 is configured to modify the set of licenses to generate the modified set of licenses 214E based on the application of the ML model to the set of licenses 214C, the consumption data 214B, and the input data 214D. In an embodiment, each license of the modified set of licenses 214C indicates a scaling (upscaling or downscaling) of the respective application of the set of applications 214A. In an embodiment, the count of licenses in the modified set of licenses indicates the number of licenses that need to be allocated to each application of the set of applications 214A, to maintain the respective application in the working state while maintaining the set of parameters (the first threshold cost) provided in the input data 214D. In an embodiment, the modified set of licenses 214E indicates the licenses that need to be allocated to the respective container application to keep the respective container application of the set of container application 214A in the working state.

By way of example, and not by limitation, the system 202 determines that 1 additional license needs to be allocated to the first application, since the first application is currently performing 590 GB of data transfer per month (and can perform a maximum 600 GB of data transfer under the terms and conditions of the 3 licenses allocated to it) and the traffic on the first application is increasing progressively. Also, the cost of hosting the first application even after the allocation of an additional license ($800) will be under the first threshold cost ($1000). Hence, the system 202 modifies the set of licenses associated with the first application from 3 licenses to 4 licenses. The system 202 further determines that 1 license can be collected back from the second application, since the application is currently performing only 400 GB of data transfer and the traffic on the second application is decreasing progressively.

At 412, a protocol table generation operation is performed. In the protocol table generation operation, the system 202 is configured to generate the protocol table that includes the modified set of licenses 214E, the consumption data 214B, and the set of licenses 214C that are currently allocated to the set of applications 214A. In an embodiment, the system 202 is configured to generate the protocol table to indicate the user 216 about the modification of the set of licenses 214C. By way of example, and not by limitation, the system 202 generates the protocol table for the first and the second applications. The protocol table includes the consumption data (the traffic data and the resource utilization data) associated with the first and the second application, the set of licenses currently allocated to them, and the modified set of licenses that need to be allocated, the protocol table is provided, in Table 1 below:

TABLE 1
Protocol Table

| | | | | | Suggested |
|---|---|---|---|---|---|
| | | | | | Licenses |
| | | | Consumption | | that need to |
| | | | Data | | be allocated |
| | | Consumption | (Data | Trend of | to keep the |
| | Currently | Data | transfer | Consumption | application |
| | Allocated | (vCPU | in this | (Traffic | in working |
| Application | Licenses | usage) | case) | trend) | state |
| First | 3 | 22 vCPUs of | 590 GB of | Traffic | 4 |
| Application | | 24 vCPUs | 600 GB | Increasing | |
| Second | 3 | 14 vCPUs of | 400 GB of | Traffic | 2 |
| Application | | 24 vCPUs | 600 GB | Decreasing | |

At 414, a protocol table rendering operation is performed. In the protocol table rendering operation, the system 202 is configured to render the protocol table on the user device 212. The protocol table indicates the user about the modification of the set of licenses 214C and the factors because of which the modification of the set of licenses 214C is needed. In an embodiment, the system 202 is configured to render the protocol table on the user device to obtain the approval from the user 216 for the allocation of the modified set of licenses 214E to the set of container applications 214A. In an alternate embodiment, the system 202 transmits the protocol table to the user device 212.

At 416, a second input reception operation is performed. In the second input reception operation, the system 202 is configured to receive validation data from the user device 212. The validation data may indicate one of an approval or a denial for the allocation of the modified set of licenses 214E to the set of container applications 214A. In an embodiment, the system 202 is configured to receive the input data 214D associated with the modification of the set of licenses 214C based on the transmission of the protocol table to the user device 212. By way of example, the system 202 receives an approval for the allocation of the modified set of licenses 214E to the first application and the second application.

At 418, it is determined that the validation data indicates the approval for the allocation of the modified set of licenses 214E to the set of container applications 214A. Based on the determination that the validation data indicates the approval for the allocation of the modified set of licenses 214E, the control of operation proceeds to 420 for the allocation of the modified set of licenses 214E, otherwise the control of operations moves back to 410, to regenerate the modified set of licenses 214E and regenerate the protocol table.

In an embodiment, the system 202 is further configured to receive the validation data as feedback for the ML model 208. The system 202 trains (or fine-tunes) the ML model based on the feedback. Based on the approval (positive feedback), the system 202 reinforces the weights and the hyperparameters so that the future predictions of the ML model 208 are accurate. Based on the denial (the negative feedback), the system 202 adjusts the weights and the hyperparameters of the ML model 208 until the training error is minimized or the minima of the loss function is achieved. Details about the training of the ML model 208 are further provided, for example, in FIG. 6.

At 420, a license allocation operation is performed. In the license allocation operation, the system 202 is configured to control the allocation of the modified set of licenses 214E to the set of applications 214A based on the determination of the approval. In an embodiment, the system 202 is further configured to allocate new licenses to the set of applications 214A and collect back (or deallocate) the licenses currently allocated to the set of applications 214A (underutilization scenario) based on the approval.

In an embodiment, for the allocation of new licenses, the system 202 is configured to obtain the license agreement, get the license agreement digitally signed from the user 216 via the user device 212, and then submit the license agreement to the licensor for approval. Similarly, for the deallocation of the licenses, the system 202 is configured to obtain a license cancellation document from the one or more data sources 204, get the license cancellation document digitally signed by the user 216 via the user device 212, and then submit the license cancellation document to the licensor for cancellation. Similar to the license agreement, the license cancellation document is a legal agreement between the licensee and the licensor, for the cancellation of licenses.

By way of example, and not by limitation, the system 202 receives an approval to collect back one license from the second application. The system 202 determines that the total cost of hosting the first application upon the allocation of 1 additional license to the first application ($800/month) is less than the first threshold cost ($1000/month). Hence, the system 202 allocates 1 additional license to the first application and collects back (deallocates) 1 license from the 3 licenses allocated to the second application. The system 202 similarly obtains the license agreement (first application) and the license cancellation document (second application), gets the license agreement and the license cancellation document digitally signed by the user 216 via the user device 212, and submits the license agreement and the license cancellation document to the licensor. In an embodiment, the system 202 is further configured to control a deployment of the set of applications 214A based on the allocation of the modified set of licenses 214E to the set of applications 214A. Details about the application deployment control are provided, for example, in FIG. 4B.

Since the system 202 is configured to control the allocation of only the modified set of licenses 214E, that is needed to keep the set of container applications 214A in the working state, hence the system 202 reduces the processing time for controlling the allocation of the licenses. Controlling only the allocation of the modified set of licenses 214E that are needed by the container applications to keep the container applications in working state eliminates the problems associated with controlling the allocation of the unnecessary licenses that are not even being utilized by the set of container applications 214A. Hence the system 202 reduces the processing time for the controlling the allocation of the licenses since now only the allocation of the modified set of licenses 214E that are needed to keep the set of container applications 214A in the working state, needs to be controlled.

FIG. 4B is a diagram that illustrates exemplary operations for controlling deployments of container applications using license management, in accordance with an embodiment of the disclosure. FIG. 4B is explained in conjunction with elements from FIG. 1, FIG. 2, FIG. 3, and FIG. 4A. With reference to FIG. 4B, there is shown the block diagram 400B that illustrates exemplary operations from 422 to 430, as described herein. The exemplary operations illustrated in the block diagram 400B start at 422 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 400B can be divided into additional blocks, combined into fewer blocks, or eliminated, depending on the implementation.

At 422, a custom resource definition modification operation is performed. In the custom resource definition modification operation, the system 202 is configured to modify a set of CRDs associated with the set of applications 214A based on the allocation of the modified set of licenses to the set of applications 214A. As discussed above, the set of CRDs is deployed with the control plane 302 of the container platform 300. Each CRD of the set of CRD is indicative of the set of licenses 214C that were allocated to the respective container application of the set of container applications 214A. In an embodiment, each CRD of the set of CRDs associated with the set of applications 214A defines specific configurations of the respective application such as resource limits, data transfer limits, or the like, which are defined as per the terms and conditions of the set of licenses 214C. Hence, the set of CRDs is indicative of the set of licenses 214C that were allocated to the set of container applications 214A. In an embodiment, the system 202 is configured to modify the specific configurations defined in the set of CRDs based on the terms and conditions of the modified set of licenses 214E. For example, in case the resource limits need to be increased based on the allocation of new licenses, the system 202 updates the resource limits in the CRD. Hence, the modified set of CRDs is indicative of the modified set of licenses 214E since the system 202 modifies the set of CRDs based on the terms and conditions of the modified set of licenses 214E.

At 424, a custom resource modification operation is performed. In the custom resource modification operation, the system 202 is configured to modify a set of custom resources associated with the set of applications 214A based on the modified set of custom resource definitions and the allocation of the modified set of licenses 214E to the set of applications 214A. In an embodiment, each custom resource of the set of custom resources corresponds to a run-time instance of a respective CRD of the set of CRDs. As discussed above, each custom resource of the set of custom resources is deployed within the data plane 304 of the container platform 300. Each custom resource of the set of custom resources is implemented as yet another markup language (YAML) file in the data plane 304 of the container platform 206. The YAML files describe the specific configurations of each application of the set of applications 214A such as the resource limits, data transfer limits, or the like, which are defined as per the terms and conditions of the set of licenses 214C. Hence, the set of custom resources is indicative of the set of licenses 214C that were allocated to the container applications 214A. In an embodiment, the system 202 is configured to modify the specific configurations defined in the YAML files corresponding to the set of custom resources based on the terms and conditions of the modified set of licenses 214E. Hence, the modified set of custom resources is indicative of the modified set of licenses 214E since the system 202 modifies the set of custom resources based on the terms and conditions of the modified set of licenses 214E.

By way of example, and not by limitation, the system 202 modifies the custom resources associated with the first application. The system 202 increases the resource limits of vCPUs from 24 vCPUs to 32 vCPUs based on the allocation of the new license (that increases the number of vCPUs) and further increases the data transfer limits from 600 GB per month to 800 GB per month in the custom resource of the first application. Similarly, the system 202 further modifies the resource limits in the custom resources of the second application from 24 vCPUs to 16 vCPUs and the data transfer limits from 600 GB to 400 GB.

At 426, a custom resource definition deployment operation is performed. In the custom resource definition deployment operation, the system 202 is configured to control a deployment of the modified set of CRDs associated with each application of the set of applications 214A within the control plane 302 of the container platform 300. The system 202 may be configured to control the deployment of the modified set of CRDs to ensure that the changes based on the modified set of licenses 214E are implemented to the respective application, and the respective application is in the working state. In an embodiment, the modified set of CRDs is indicative of the modified set of licenses 214E since the system 202 modifies the set of CRDs based on the terms and conditions of the modified set of licenses 214E.

At 428, a custom resource deployment operation is performed. In the custom resource deployment operation, the system 202 is configured to control a deployment of the modified set of custom resources associated with each application of the set of applications 214A within the data plane 304 of the container platform 300. The system 202 may be configured to control the deployment of the modified set of custom resources to ensure that the changes based on the modified set of licenses 214E are implemented to the respective application, and the respective application is in the working state. In an embodiment, the modified set of custom resources is indicative of the modified set of licenses 214E since the system 202 modifies the set of custom resources based on the terms and conditions of the modified set of licenses 214E.

At 430, an application deployment control operation is performed. In the application deployment control operation, the system 202 is configured to control a deployment of each application of the set of applications 214A within the container platform 206 based on the deployment of the modified set of CRDs and the modified set of custom resources. In an embodiment, the system 202 is further configured to control the deployment of each application of the set of applications 214A based on the allocation of the modified set of licenses 214E to the respective application of the set of applications 214A. By way of example, and not by limitation, the system 202 controls the deployment of the first application and the second application based on the allocation of the modified set of licenses.

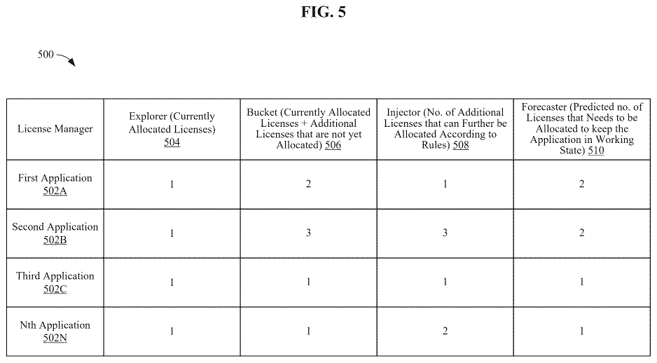

FIG. 5 is a diagram that illustrates an exemplary table for license management in container platforms, in accordance with an embodiment of the disclosure. FIG. 5 is explained in conjunction with FIG. 1, FIG. 2, FIG. 3, FIG. 4A, and FIG. 4B. With reference to FIG. 5, there is further shown a table 500. The table 500 includes a set of rows for the set of applications 214A. The set of rows includes a first row 502A labeled as “first application”, a second row 502B labeled as “second application”, a third row 502C labeled as “third application”, up to an Nth row 502N labeled as “Nth application”.

With reference to FIG. 5, the table 500 further includes a set of columns for the components (explorer 306A, bucket 306B, injector 306C, and forecaster 306D) of the license controller 306. The set of columns includes a first column 504 labeled as “Explorer”, a second column 506 labeled as “Bucket”, a third column 508 labeled as “Injector”, and a fourth column 510 labeled as “Forecaster”.

In an embodiment, the first column 504 (explorer) of the table 500 indicates a count of licenses (the set of licenses) that are currently allocated to each application of the set of applications 214A. For example, as illustrated in FIG. 5, “1 license is currently allocated to each application of the set of applications 214A. In an embodiment, the second column 506 (bucket) of the table 500 indicates a count of licenses that are currently allocated to the set of applications 214A and the count of licenses that are not yet allocated to the set of applications 214A. As discussed above, the second column 506 (the bucket) further includes the licenses that have been collected back from the set of applications 214A (underutilization scenario).

In an embodiment, the third column 508 (injector) further indicates the count of licenses that the user allows (or wishes) to be associated with the set of applications 214A based on the set of parameters (input data 214D). For example, as illustrated in FIG. 5, in case of the second application, the user allows for 3 licenses to be allocated. In an embodiment, the fourth column 510 (forecaster) further indicates the count of licenses that need to be allocated to each application of the set of applications 214A in order to maintain the respective application in the working state while maintaining the cost of hosting the respective application. For example, as illustrated in FIG. 5, in case of the third application, the forecaster predicts that 1 license should be allocated to maintain the third application in working state while maintaining the cost.

FIG. 6 is a diagram that illustrates training of a machine learning (ML) model for license management in container platforms, in accordance with an embodiment of the disclosure. FIG. 6 is explained in conjunction with FIG. 1, FIG. 2, FIG. 3, FIG. 4A, FIG. 4B, and FIG. 5. As shown, there is a training portion above line 600 and an implementation portion below line 600. With reference to FIG. 6, is further shown the ML model 208. In the training portion above line 600, the computer system 202 retrieves historical consumption data and a plurality of modified licenses from the one or more data sources 204 to generate a training dataset and for training 602 of the ML model 208 based on the training dataset.

At 604, a historical data retrieval operation is performed. In the historical data retrieval operation, the system 202 is configured to retrieve historical consumption data associated with a plurality of container applications and a plurality of licenses associated with the plurality of container applications. The plurality of licenses corresponds to the licenses that were historically allocated (at a timestamp t1) to each application of the plurality of container applications (may be referred to as a plurality of applications, hereinafter). In an embodiment, the historical consumption data includes historical traffic data associated with each application of the plurality of applications, historical transaction data associated with each application of the plurality of applications, historical configuration data associated with each application of the plurality of applications, and historical resource utilization data associated with each application of the plurality of applications.

The historical traffic data indicates the traffic (a volume of data transmitted to and from each application of the plurality of applications) at the timestamp t1. The historical traffic data further indicate the number of user interactions and network load on each application of the plurality of applications at timestamp t1. The historical resource utilization data indicates consumption of resources (such as vCPUs, memory, disk I/O, network bandwidth, or the like) by each application of the plurality of applications at timestamp t1. The transaction data indicates the details of individual transactions processed by each application of the plurality of applications, including inputs, outputs, and timestamps. The configuration data includes the specific configuration settings and configuration parameters that define how each application of the plurality of applications was set up at timestamp t1.

By way of example, and not by limitation, the system 202 obtains the plurality of licenses associated with four applications and the historical consumption data associated with the four applications, the historical data can be represented in Table 2 below:

TABLE 2
Historical Data

| | | | Consumption | |
|---|---|---|---|---|
| | | Consumption | Data | |
| | Allocated | Data | (Data transfer | Trend of |
| | Licenses | (vCPU usage) | in this case) | Consumption |
| | (at timestamp | (at timestamp | (at timestamp | (Traffic |
| Application | t1) | t1) | t1) | trend) |
| First | 4 (provides a | 30 vCPUs of 32 | 750 GB of 800 | Traffic |
| Application | total limit of 32 | vCPUs | GB | Increasing |
| | vCPUs and 800 | | | |
| | GB data transfer) | | | |
| Second | 3 (provides a | 14 vCPUs of 24 | 400 GB of 600 | Traffic |
| Application | total limit of 24 | vCPUs | GB | Decreasing |
| | vCPUs and 600 | | | |
| | GB data transfer) | | | |
| Third | 3 (provides a | 18 vCPUs of 24 | 450 GB of 600 | Traffic |
| Application | total limit of 24 | vCPUs | GB | Increasing |
| | vCPUs and 600 | | | |
| | GB data transfer) | | | |
| Fourth | 2 (provides a | 14 vCPUs of 16 | 390 GB of 400 | Traffic |
| Application | total limit of 16 | vCPUs | GB | Increasing |
| | vCPUs and 400 | | | |
| | GB data transfer) | | | |

At 606, a plurality of modified licenses retrieval operation, is performed. In the plurality of modified licenses retrieval operation, the system 202 is configured to retrieve a plurality of modified licenses associated with each application of the plurality of applications. The plurality of modified licenses includes the licenses that were historically allocated to the plurality of applications at a timestamp t2 (after the timestamp t1). In an embodiment, each license of the plurality of modified licenses indicates a scaling (upscaling or downscaling) of a respective application of the plurality of applications. For example, in case an additional new license had been allocated to an application at the timestamp t2 after t1, the new license may indicate that the traffic on the application may have increased, and the application must have been scaled up. Similarly, in a scenario where a license had been collected back from an application at timestamp t2 after t1, the deallocated license may indicate that the application must have scaled down.

At 608, a training dataset generation operation is performed. In the training dataset generation operation, the system 202 is configured to generate a training dataset based on the plurality of licenses, the historical consumption data, and the plurality of modified licenses. In an embodiment, the training dataset includes a set of inputs (the plurality of licenses and the historical consumption data) and a set of outputs (the plurality of modified licenses). The training dataset is further used for training 602 of the ML model 208. The system 202 trains the ML model 208 for predicting the set of outputs (the plurality of modified licenses) based on the set of inputs (the plurality of licenses and the historical consumption data).

By way of example, and not by limitation, the system 202 generates the training dataset for the four applications, the training dataset is provided in Table 3 below:

TABLE 3
Training Dataset

| Input | | | | | |
|---|---|---|---|---|---|
| | | | Consumption | | Output |
| | | Consumption | Data | | Modified |
| | Allocated | Data | (Data transfer | Trend of | Licenses |
| | Licenses | (vCPU usage) | in this case) | Consumption | (Licenses |
| | (at timestamp | (at timestamp | (at timestamp | (Traffic | at timestamp |
| Application | t1) | t1) | t1) | trend) | t2) |
| First | 4 (provides | 30 vCPUs of | 750 GB of 800 | Traffic | 5 |
| Application | a total limit | 32 vCPUs | GB | Increasing | |
| | of 32 | | | | |
| | vCPUs and | | | | |
| | 800 GB | | | | |
| | data | | | | |
| | transfer) | | | | |
| Second | 3 (provides | 14 vCPUs of | 400 GB of 600 | Traffic | 2 |
| Application | a total limit | 24 vCPUs | GB | Decreasing | |
| | of 24 | | | | |
| | vCPUs and | | | | |
| | 600 GB | | | | |
| | data | | | | |
| | transfer) | | | | |
| Third | 3 (provides | 18 vCPUs of | 450 GB of 600 | Traffic | 3 |
| Application | a total limit | 24 vCPUs | GB | Increasing | |
| | of 24 | | | | |
| | vCPUs and | | | | |
| | 600 GB | | | | |
| | data | | | | |
| | transfer) | | | | |
| Fourth | 2 (provides | 14 vCPUs of | 390 GB of 400 | Traffic | 3 |
| Application | a total limit | 16 vCPUs | GB | Increasing | |
| | of 16 | | | | |
| | vCPUs and | | | | |
| | 400 GB | | | | |
| | data | | | | |
| | transfer) | | | | |

At 610 an ML model training operation is performed. In the ML model training operation, the system 202 is configured to train the ML model 208 based on the training dataset. Specifically, the computer system 202 provides the ML model 208 with the set of inputs (the plurality of licenses and the historical consumption data) from the training dataset. The ML model 208 analyzes the set of inputs (the plurality of licenses and the historical consumption data), determines a machine learning algorithm for the prediction of the output (the plurality of modified licenses) using the input (plurality of licenses and the historical consumption data), and estimates the values of the weights and the hyperparameters.

The computer system 202 further adjusts the values of weights and the hyperparameters based on a determination that the predicted first output (predicted modified license) does not match the actual first output (the actual modified license) in the training dataset. The computer system 202 further repeats the adjustment of the values of the weights and the hyperparameters until the minima of the loss function is achieved or the training error is minimized.

In the implementation portion below line 600, an input 612 is received. The input 612 includes the set of licenses 214C that are currently allocated to the set of applications 214A and the consumption data 214B associated with the set of applications 214A. By way of example, and not by limitation, the system 202 receives the input 612. The input 612 indicates that 3 licenses have been allocated to each of a first application and a second application of the set of applications. Each license of the 3 licenses indicates that the first application and the second application can be allocated 8 vCPUs based on the terms and conditions of the license. Hence, according to the 3 licenses, the first application and the second application can be allocated 24 vCPUs (8*3) each. The input 612 further includes the consumption data that indicates that the first application is currently utilizing 22 vCPUs of the 24vCPUs that have been allocated, and the traffic data indicates that the traffic on the first application is increasing progressively. The consumption data further indicates that the second application is currently utilizing 14 vCPUs of the 24vCPUs that have been allocated, and the traffic data indicates that the traffic on the second application is decreasing progressively.

At 614, an ML model application operation is performed. In the ML model application operation, the system 202 is configured to apply the trained ML model 208 to the set of licenses 214C and the consumption data 214B. The trained ML model 208 is configured to analyze the consumption data 214B and the set of licenses that are currently allocated to each application of the set of applications. Based on the analysis, the trained ML model 208 is further configured to predict the number of licenses (modified set of licenses 214E) that need to be allocated to the respective application to maintain the respective application in the working state while maintaining the cost of hosting the respective application. Details about the ML model application operation are provided, for example, in FIG. 2 and FIG. 4A.

At 616, a modified set of licenses generation operation is performed. In the modified set of licenses generation operation, the system 202 is configured to generate the modified set of licenses 214E based on the application of the trained ML model 208 to the set of licenses 214C and the consumption data 214B. In an embodiment, each license of the modified set of licenses 214C indicates a scaling (upscaling or downscaling) of the respective application of the set of applications 214A. In an embodiment, the count of licenses in the modified set of licenses indicates the number of licenses that need to be allocated to each application of the set of applications 214A, to maintain the respective application in the working state while maintaining the cost of hosting the respective application. Details about the modified set of license generation operation are provided, for example, in FIG. 2 and FIG. 4A.

By way of example, and not by limitation, the system 202 determines that 1 additional license needs to be allocated to the first application since the first application is currently utilizing 22 vCPUs of the 24vCPUs that are allocated, under the terms and conditions of the 3 licenses allocated, and the traffic on the first application is increasing progressively. Hence, the system 202 modifies the set of licenses associated with the first application from 3 licenses to 4 licenses. The system 202 further determines that 1 license can be collected back from the second application since the application is currently utilizing only 14 vCPUs of the 24 vCPUs allocated to it, and the traffic on the second application is decreasing progressively.

At 618, a license allocation operation is performed. In the license allocation operation, the system 202 is configured to control the allocation of the modified set of licenses 214E to the set of applications 214A based on the input data 214D associated with the modification of the set of licenses 214C. In an embodiment, the system 202 is further configured to allocate new licenses to the set of applications 214A and collect back (or deallocate) the licenses currently allocated to the set of applications 214A based on the input data 214D. Details about the license allocation operation are provided, for example, in FIG. 2 and FIG. 4A.

In an embodiment, for the allocation of new licenses, the system 202 is configured to obtain the license agreement, get the license agreement digitally signed from the user 216 via the user device 212, and then submit the license agreement to the licensor for approval. Similarly, for the deallocation of the licenses, the system 202 is configured to obtain a license cancellation document from the one or more data sources 204, get the license cancellation document digitally signed by the user 216 via the user device 212, and then submit the license cancellation document to the licensor for cancellation. Similar to the license agreement, the license cancellation document is a legal agreement between the licensee and the licensor, for the cancellation of licenses.

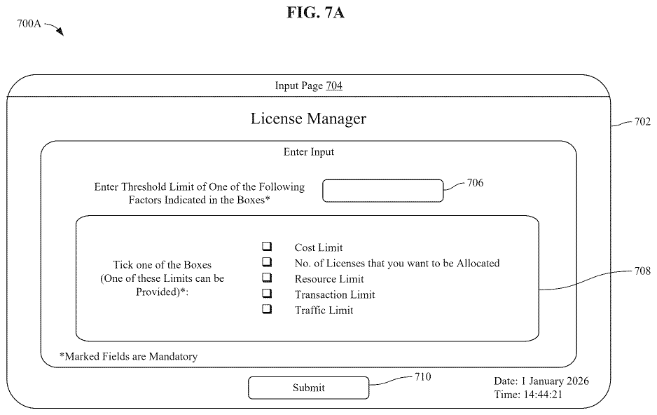

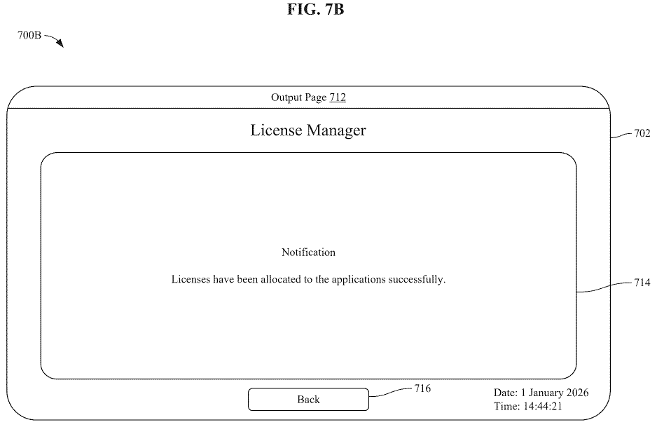

FIG. 7A is a diagram that illustrates an exemplary first user interface for license management in container platforms, in accordance with an embodiment of the disclosure. FIG. 7A is explained in conjunction with elements from FIG. 1, FIG. 2, FIG. 3, FIG. 4A, FIG. 4B, FIG. 5, and FIG. 6. With reference to FIG. 7A, there is shown an exemplary diagram 700A that includes a user device 702 and an input page 704. The input page 704 includes a first user interface (UI) element 706, a second UI element 708, and a third UI element 710. The user device 702 is an exemplary embodiment of the user device 212 of FIG. 2.

With reference to FIG. 7A, the computer system 202 renders the input page 704 on the user interface (UI) of the user device 702. The input page 704 corresponds to a web page or online form that is designed to collect information from the user 216 for the management of licenses associated with the set of applications 214A. In an embodiment of the disclosure, the input page 704 is used to obtain the input data 214D (the set of parameters) from the user for the management of licenses associated with the set of container platforms.

The first UI element 706 corresponds to a textbox labeled “Enter Threshold Limit of one of the following factors indicated in the boxes”. The first UI element 706 is used to obtain the input data 214D (the set of parameters) associated with the modification of the set of licenses 214C of the set of container applications 214A. The second UI element 708 corresponds to a textbox labeled “Tick one of the boxes (one of these limits can be provided)”. The second UI element 708 further includes a set of checkboxes. The user may provide one of the set of parameters (one of the first threshold cost, the first threshold count of resources, or the like) and select the corresponding checkbox from the set of checkboxes. Based on the selected checkbox, the system 202 is configured to identify the parameter of the set of parameters provided by the user. For example, in case the user selects the checkbox labeled “Cost Limit”, and the system 202 may identify the parameter provided by the user is the first threshold cost. In case the user selects the checkbox “Resource Limits”, the system 202 may identify the parameter provided by the user is the first threshold count of resources. In case the user selects the checkbox labeled “No. of Licenses you want to be allocated”, then the system 202 may identify the parameter provided by the user is the first threshold count of licenses. In case the user selects the checkbox labeled “Transaction Limits”, the system 202 may identify the parameter provided by the user is the first threshold count of transactions. In case the user selects the checkbox labeled “Traffic Limits”, the system 202 may identify the parameter provided by the user is the first threshold count of traffic. It may be noted that both the first UI element 706 and the second UI element 708 are mandatory input parameters that need to be provided for license management.

The third UI element 710 corresponds to a button labeled “Submit”. Upon selecting the third UI element 710, the computer system 202 receives the input data 214D (the set of parameters) and further initiates the process of license management. The system 202 receives the input data 214D. The system 202 is further configured to retrieve the set of licenses 214C associated with the set of applications 214A. The system 202 is further configured to retrieve the consumption data 214B associated with the set of applications 214A. The system 202 is further configured to apply the ML model 208 to the retrieved set of licenses 214C and the retrieved consumption data 214B. The system 202 is further configured to modify the set of licenses 214C based on the application of the ML model 208 to the retrieved set of licenses 214C and the retrieved consumption data 214B. The system 202 is further configured to control the allocation of the modified set of licenses 214E to the set of container applications 214A based on the input data 214D. Details about the license allocation operation are provided, for example, in FIG. 1 and FIG. 4A.

FIG. 7B is a diagram that illustrates an exemplary second user interface for license management in container platforms, in accordance with an embodiment of the disclosure. FIG. 7B is explained in conjunction with elements from FIG. 1, FIG. 2, FIG. 3, FIG. 4A, FIG. 4B, FIG. 5, FIG. 6, and FIG. 7A. With reference to FIG. 7B, there is shown an exemplary diagram 700B that includes the user device 702 and an output page 712. The output page 712 includes a fourth UI element 714 and a fifth UI element 716. The user device 702 is an exemplary embodiment of the user device 212 of FIG. 2.

With reference to FIG. 7B, the computer system 202 renders the output page 712 on the display unit (or the user interface) of the user device 702. The computer system 202 renders the message on the user device 702 that indicates that the licenses have been allocated to the applications. The fourth UI element 714 corresponds to a textbox that includes the message, for example, “Notification: Licenses have been allocated to the applications successfully”. The fifth UI element 716 corresponds to a button labeled “Back”. Upon Selecting the fifth UI element 716, the computer system 202 renders the input page 704 on the user device 702.

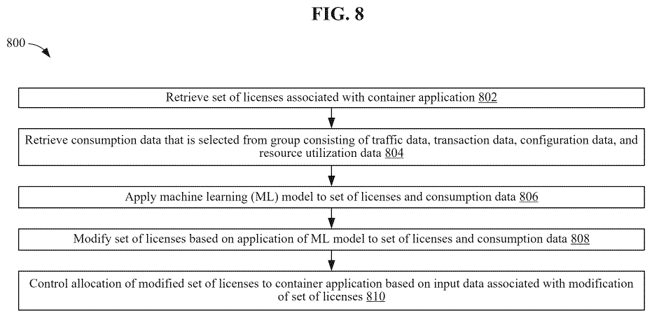

FIG. 8 is a diagram that illustrates a flowchart of a first exemplary method for license management in container platforms, in accordance with an embodiment of the disclosure. FIG. 8 is explained in conjunction with elements from FIG. 1, FIG. 2, FIG. 3, FIG. 4A, FIG. 4B, FIG. 5, FIG. 6, FIG. 7A, and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the set of licenses 214C associated with a container application (one of the set of container applications 214A) is retrieved. The container application is hosted on the container platform 206. In an embodiment of the disclosure, the system 202 is configured to retrieve the set of licenses 214C associated with the container application. The container application is hosted on the container platform 206. Details about the set of licenses retrieval operation are provided, for example, in FIG. 1 and FIG. 4A.

At 804, the consumption data 214B that is selected from the group consisting of the traffic data, the transaction data, the configuration data, and the resource utilization data is retrieved. In an embodiment of the disclosure, the system 202 is configured to retrieve the consumption data 214B that is selected from the group consisting of the traffic data associated with the container application, transaction data associated with the container application, configuration data associated with the container application, and resource utilization data associated with the container application. Details about the consumption data retrieval operation are provided, for example, in FIG. 1 and FIG. 4A

At 806, the ML model 208 is applied to the set of licenses 214C and the consumption data 214B. In an embodiment of the disclosure, the system 202 is configured to apply the ML model 208 to the set of licenses 214C and the consumption data 214B. Details about the ML model application operation are provided, for example, in FIG. 1 and FIG. 4A.

At 808, the set of licenses 214C associated with the container application is modified based on the application of the ML model 208 to the set of licenses 214C and the consumption data 214B. The modified set of licenses 214E is indicative of a scaling of the container application. In an embodiment of the disclosure, the system 202 is configured to modify the set of licenses 214C associated with the container application based on the application of the ML model 208 to the set of licenses 214C and the consumption data 214B. Details about the license modification operation are provided, for example, in FIG. 1 and FIG. 4A.

At 810, the allocation of the modified set of licenses 214E to the container application is controlled based on the input data 214D associated with the modification of the set of licenses 214C. In an embodiment of the disclosure, the system 202 is configured to control the allocation of the modified set of licenses 214E to the container application based on the input data associated with the modification of the set of licenses 214C. Details about the license allocation operation are provided, for example, in FIG. 1 and FIG. 4A.

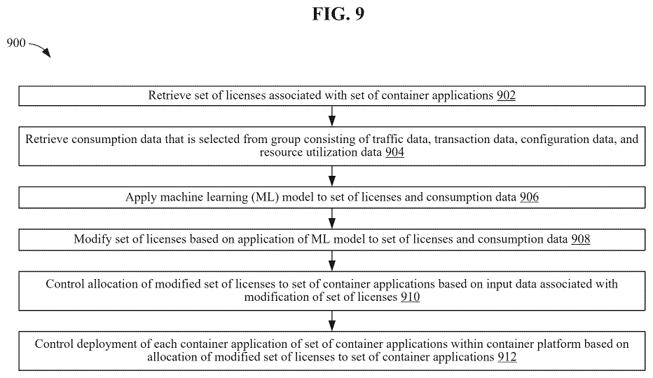

FIG. 9 is a diagram that illustrates a flowchart of a second exemplary method for license management in container platforms, in accordance with an embodiment of the disclosure. FIG. 9 is explained in conjunction with elements from FIG. 1, FIG. 2, FIG. 3, FIG. 4A, FIG. 4B, FIG. 5, FIG. 6, FIG. 7A, FIG. 7B, and FIG. 8. With reference to FIG. 9, there is shown a flowchart 900. The operations of the exemplary method may be executed by any computing system, for example, by the computer 102 of FIG. 1 or the computer system 202 of FIG. 2. The operations of the flowchart 900 may start at 902.

At 902, the set of licenses 214C associated with the set of container applications 214A is retrieved. The set of container applications 214A is hosted on the container platform 206. In an embodiment of the disclosure, the system 202 is configured to retrieve the set of licenses 214C associated with the set of container applications 214A. The set of container applications 214A is hosted on the container platform 206. Details about the set of licenses retrieval operation are provided, for example, in FIG. 1 and FIG. 4A.

At 904, the consumption data 214B that is selected from the group consisting of the traffic data, the transaction data, the configuration data, and the resource utilization data, is retrieved. In an embodiment of the disclosure, the system 202 is configured to retrieve the consumption data 214B that is selected from the group consisting of the traffic data associated with the set of container applications 214A, the transaction data associated with the set of container applications 214A, the configuration data associated with the set of container applications 214A, and the resource utilization data associated with the set of container applications 214A. Details about the consumption data retrieval operation are provided, for example, in FIG. 1 and FIG. 4A.

At 906, the ML model 208 is applied to the set of licenses 214C and the consumption data 214B. In an embodiment of the disclosure, the system 202 is configured to apply the ML model 208 to the set of licenses 214C and the consumption data 214B. Details about the ML model application operation are provided, for example, in FIG. 1 and FIG. 4A.

At 908, the set of licenses 214C associated with the set of container applications 214A is modified based on the application of the ML model 208 to the set of licenses 214C and the consumption data 214B. The modified set of licenses 214E is indicative of a scaling of the container application. In an embodiment of the disclosure, the system 202 is configured to modify the set of licenses 214C associated with the set of container applications 214A based on the application of the ML model 208 to the set of licenses 214C and the consumption data 214B. Details about the license modification operation are provided, for example, in FIG. 1 and FIG. 4A.

At 910, the allocation of the modified set of licenses 214E to the set of container applications 214A is controlled based on the input data 214D associated with the modification of the set of licenses 214C. In an embodiment of the disclosure, the system 202 is configured to control the allocation of the modified set of licenses 214E to the set of container applications 214A based on the input data associated with the modification of the set of licenses 214C. Details about the license allocation operation are provided, for example, in FIG. 1 and FIG. 4A.

At 912, the deployment of each container application of the set of container applications 214A is controlled within the container platform 206 based on the allocation of the modified set of licenses 214E to the set of container applications 214A. In an embodiment, the system 202 is configured to control the deployment of the set of container applications 214A within the container platform 206 based on the allocation of the modified set of licenses 214E to the set of container applications 214A. Details about the application deployment control operation are provided, for example, in FIG. 4B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable people of ordinary skill in the art to understand the embodiments disclosed herein.

What is claimed is:

1. A computer-implemented method, comprising:
retrieving, by a computer, a set of licenses associated with a container application hosted on a container platform;
retrieving, by the computer, consumption data selected from the group consisting of: traffic data associated with the container application, transaction data associated with the container application, configuration data associated with the container application, and resource utilization data associated with the container application;
applying, by the computer, a machine learning (ML) model to the set of licenses and the consumption data;
modifying, by the computer, the set of licenses based on the application of the ML model to the set of licenses and the consumption data; and
controlling, by the computer, an allocation of the modified set of licenses to the container application based on input data associated with the modification of the set of licenses associated with the container application.

2. The computer-implemented method of claim 1, further comprising:
generating, by the computer, a protocol table comprising the set of licenses, the modified set of licenses, and the consumption data;
transmitting, by the computer, the protocol table to a user device; and
receiving, by the computer, the input data associated with the modification of the set of licenses based on the transmission of the protocol table to the user device.

3. The computer-implemented method of claim 1, further comprising:
applying, by the computer, the ML model to the set of licenses, the consumption data, and the input data, wherein the input data comprises a set of parameters associated with the container application;
modifying, by the computer, the set of licenses based on the application of the ML model to the set of licenses, the consumption data, and the input data; and
controlling, by the computer, the allocation of the modified set of licenses to the container application based on the set of parameters.

4. The computer-implemented method of claim 3, wherein the set of parameters are selected from the group consisting of: a threshold cost associated with the container application, a threshold count of licenses in the modified set of licenses, a threshold count of resources associated with the container application, a threshold count of transactions associated with the container application, and a threshold count of traffic associated with the container application.

5. The computer-implemented method of claim 3, further comprising controlling, by the computer, a deployment of the container application within the container platform based on the allocation of the modified set of licenses to the container application.

6. The computer-implemented method of claim 5, further comprising:
modifying, by the computer, a set of custom resource definitions associated with the container application based on the allocation of the modified set of licenses to the container application, wherein the set of custom resource definitions is indicative of the set of licenses associated with the container application, and wherein the set of custom resource definitions is deployed within a control plane of the container platform;
modifying, by the computer, a set of custom resources associated with the container application based on the allocation of the modified set of licenses to the container application, wherein the set of custom resources is indicative of the set of licenses associated with the container application, and wherein the set of custom resources is deployed within a data plane of the container platform; and
controlling, by the computer, the deployment of the container application within the container platform based on the modified set of custom resource definitions and the modified set of custom resources.

7. The computer-implemented method of claim 6, further comprising:
controlling, by the computer, a deployment of the modified set of custom resource definitions within the control plane of the container platform, wherein the modified set of custom resource definitions is indicative of the modified set of licenses;
controlling, by the computer, a deployment of the modified set of custom resources within the data plane of the container platform, wherein the modified set of custom resources is indicative of the modified set of licenses; and
controlling, by the computer, the deployment of the container application within the container platform based on the deployment of the modified set of custom resources and the modified set of custom resource definitions.

8. The computer-implemented method of claim 1, further comprising:
retrieving, by the computer, historical consumption data associated with a plurality of container applications and a plurality of licenses associated with the plurality of container applications, wherein the plurality of container applications is inclusive of the container application and the plurality of licenses is inclusive of the set of licenses;
retrieving, by the computer, a plurality of modified licenses associated with the plurality of container applications, and wherein the plurality of modified licenses is inclusive of the modified set of licenses;
generating, by the computer, a training dataset comprising the historical consumption data, the plurality of licenses, and the plurality of modified licenses; and
training, by the computer, the ML model based on the training dataset.

9. The computer-implemented method of claim 1, further comprising:
receiving, by the computer, feedback associated with the modified set of licenses; and
training, by the computer, the ML model based on the feedback.

10. A computer system, comprising:
a processor set;
one or more computer-readable storage media; and
program instructions stored on the one or more computer-readable storage media, the program instructions executable by the processor set to cause the processor set to:
retrieve a set of licenses associated with a set of container applications hosted on a container platform;
retrieve consumption data selected from the group consisting of: traffic data associated with each container application of the set of container applications, transaction data associated with each container application of the set of container applications, configuration data associated with each container application of the set of container applications, and resource utilization data associated with each container application of the set of container applications;
apply a machine learning (ML) model to the set of licenses and the consumption data;
modify the set of licenses based on the application of the ML model to the set of licenses and the consumption data;
control an allocation of the modified set of licenses to the set of container applications based on input data associated with the modification of the set of licenses associated with the set of container applications; and
control a deployment of each container application of the set of container applications within the container platform based on the allocation of the modified set of licenses to the set of container applications.

11. The computer system of claim 10, wherein the program instructions further cause the processor set to:
generate a protocol table that comprises the set of licenses, the modified set of licenses, and the consumption data;
transmit the protocol table to a user device; and
receive the input data associated with the modification of the set of licenses based on the transmission of the protocol table to the user device.

12. The computer system of claim 10, wherein the program instructions further cause the processor set to:
apply the ML model to the set of licenses, the consumption data, and the input data, wherein the input data comprises a set of parameters associated with each container application of the set of container applications;
modify the set of licenses based on the application of the ML model to the set of licenses, the consumption data, and the input data; and
control the allocation of the modified set of licenses to the set of container applications based on the set of parameters.

13. The computer system of claim 12, wherein the set of parameters are selected from the group consisting of: a threshold cost associated with each container application of the set of container applications, a threshold count of licenses in the modified set of licenses, a threshold count of resources associated with each container application of the set of container applications, a threshold count of transactions associated with each container application of the set of container applications, and a threshold count of traffic associated with each container application of the set of container applications.

14. The computer system of claim 10, wherein the program instructions further cause the processor set to:
modify a set of custom resource definitions associated with the set of container applications based on the allocation of the modified set of licenses to the set of container applications, wherein the set of custom resource definitions is indicative of the set of licenses associated with the set of container applications, and wherein the set of custom resource definitions is deployed within a control plane of the container platform;
modify a set of custom resources associated with the set of container applications based on the allocation of the modified set of licenses to the set of container applications, wherein the set of custom resources is indicative of the set of licenses associated with the set of container applications, and wherein the set of custom resources is deployed within a data plane of the container platform; and
control the deployment of each container application of the set of container applications within the container platform based on the modified set of custom resource definitions and the modified set of custom resources.

15. The computer system of claim 14, wherein the program instructions further cause the processor set to:
control a deployment of the modified set of custom resource definitions within the control plane of the container platform, wherein the modified set of custom resource definitions is indicative of the modified set of licenses;
control a deployment of the modified set of custom resources within the data plane of the container platform, wherein the modified set of custom resources is indicative of the modified set of licenses; and
control the deployment of each container application of the set of container applications within the container platform based on the deployment of the modified set of custom resources and the modified set of custom resource definitions.

16. The computer system of claim 10, wherein the program instructions further cause the processor set to:
retrieve historical consumption data associated with a plurality of container applications and a plurality of licenses associated with the set of container applications, wherein the plurality of container applications is inclusive of the set of container applications and the plurality of licenses is inclusive of the set of licenses;
retrieve a plurality of modified licenses associated with the plurality of container applications, wherein the plurality of modified licenses is inclusive of the modified set of licenses;
generate a training dataset that comprises the historical consumption data, the plurality of licenses, and the plurality of modified licenses; and
train the ML model based on the training dataset.

17. The computer system of claim 10, wherein the program instructions further cause the processor set to:
receive feedback associated with the modified set of licenses; and
train the ML model based on the feedback.

18. A computer-program product for controlling an allocation of a set of licenses to a container application, the computer-program product comprising:
one or more computer-readable storage media; and
program instructions stored on the one or more computer-readable storage media to perform operations comprising:
retrieving the set of licenses associated with the container application hosted on a container platform;
retrieving consumption data selected from the group consisting of: traffic data associated with the container application, transaction data associated with the container application, configuration data associated with the container application, and resource utilization data associated with the container application;
applying a machine learning (ML) model to the set of licenses and the consumption data;
modifying the set of licenses based on the application of the ML model to the set of licenses and the consumption data; and
controlling the allocation of the modified set of licenses to the container application based on input data associated with the modification of the set of licenses associated with the container application.

19. The computer-program product of claim 18, wherein the program instructions stored on the one or more computer-readable storage media perform the operations further comprising:
generating a protocol table that comprises the set of licenses, the modified set of licenses, and the consumption data;
transmitting the protocol table to a user device; and
receiving the input data associated with the modification of the set of licenses based on the transmission of the protocol table to the user device.

20. The computer-program product of claim 18, wherein the program instructions stored on the one or more computer-readable storage media perform the operations further comprising:
applying the ML model to the set of licenses, the consumption data, and the input data, wherein the input data comprises a set of parameters associated with the container application, and wherein the set of parameters are selected from the group consisting of: a threshold cost associated with the container application, a threshold count of licenses in the modified set of licenses, a threshold count of resources associated with the container application, a threshold count of transactions associated with the container application, and a threshold count of traffic associated with the container application;
modifying the set of licenses based on the application of the ML model to the set of licenses, the consumption data, and the input data; and
controlling the allocation of the modified set of licenses to the container application based on the set of parameters.
